(19) United States
(12) Patent Application Publication
(10) Pub. No.: US 2005/0017412 A1
(43) Pub. Date: Jan. 27, 2005

(54) Methods and devices for producing homogeneous mixtures and for producing and testing moulded bodies

(76) Inventors: Gerhard Maier, Munich (DE); Roland Rehmet, kaufbeuren (DE); Jurgen Stebani, Kaufbeuren (DE); Christian Schneider, Erlangen (DE)

Correspondence Address: KENYON & KENYON, ONE BROADWAY, NEW YORK, NY, 10004, US

(21) Appl. No.: 10/487,778

(22) PCT Filed: Aug. 23, 2002
(86) PCT No.: PCT/EP02/09456

(30) Foreign Application Priority Data
Aug. 23, 2001 (DE) 101 41 459.5

(51) Int. Cl. B29C 47/36

(52) U.S. Cl. 264/328.17; 425/207; 425/587; 366/91

(57) ABSTRACT

The invention relates to methods and devices for the rapid preparation of homogenous mixtures of multi component systems, e.g. plastics mixtures, and for the production and testing of mouldings made therefrom. A device for the production of mouldings comprises:
a supply and rough mixer means (40) including
   conveying means (41) having one or more inlets (42) for at least one of the viscous or pasty fluids of the multi component systems as a material for a primary flow (43) which can supply the material as a primary flow (43) with a constant and selectable throughput in a predetermined flow direction (44), and
   a rough mixer means (45) comprising:
      a main inlet (47) for the primary flow (43) from the conveying means (41),
      inlets (48) for the other components of the multi component system (A or B) disposed substantially in the same plane (52) transverse to the flow direction (44) of the primary flow (43), and
      introduction means (49) connected to the inlets (48) and formed so that the other components of the multi component system can be introduced into the primary flow (43) in the form of secondary flows (50, 51), and
mixer means (53) having a radial mixing effect as well as possibly a moulding tool.

The invention relates to methods and devices for the rapid preparation of homogenous or semi-homogenous mixtures of multi-component systems, particularly of different plastics mixtures, and for preparing and possibly also for handling and testing mouldings produced from such mixtures.

The preparation of mouldings from various plastics mixtures is, for example, important in the development of optimised plastic compositions, in the development of novel blend systems or for testing the properties of new additives in a plastic matrix. To this end in many cases series of experiments have to be carried out with numerous plastics mixtures the composition of which is changed stepwise, for example to determine the influence of changing quantities of a component on the properties of the mixtures and mouldings obtained.

Such experiments have so far been carried out in a comparably slow and little economic way, for example by mixing the plastic components with the aid of a mixer device, for example a kneader or extruder, and then moulding them, usually in the form of a granulate, in plastic injection moulding machines in a separate step. The mouldings are then tested in a following step, for example with respect to their mechanical and thermal characteristics as well as other technically relevant properties. The determination of said characteristics is laid down in various test standards; the data obtained using, for example, the DIN standards can then immediately be compared to each other.

The problem arising in connection with the described procedure comprising said separate, not integrated, independent steps is mainly the time required for the preparation of the individual plastics mixtures, for moulding the mixtures, for example in injection moulding machines, and for testing the produced mouldings in testing machines. Another disadvantage is that a long dwell time of the respective plastics mixture is required due to the back-mixing occurring in the commonly used mixers, like, for example, double screw extruders or kneaders. This results in a relatively high expenditure of time for rinsing the device and changing the mixtures. According to this method, correspondingly, only a few thousand mixtures a year can be prepared and tested per technical unit comprising the compounding unit, an injection moulding machine and testing equipment. Therefore only a small selection of the possible formulas could be prepared and tested so far while, among other proposals, efforts were made to develop the unexamined mixture ranges theoretically by interpolation of the measured values using various methods of statistical experiment design.

There are, however, questions the answers to which require considerably more plastics mixtures to be prepared, processed to mouldings and tested. For example in case of a combination of two to three plastic materials with two to three additives from which mouldings are to be formed while the composition is varied in steps of approximately one percent with respect to all components, the conventional method is unsuitable for providing the desired results within a sufficiently short period of time.

From patent literature numerous devices are known the object of which is only the preparation of mixtures of plastic materials.

In the DE 196 53 099 a device is described in which at least two plastic components are introduced into a mechanically driven mixer element, mixed in it and then conveyed into an injection moulding tool to obtain a thorough mixture of the materials processed.

In the DE 198 08 620 a device extended as compared to the DE 196 53 099 is described which includes additional storage elements comprised of a cylinder with a piston to enable the use of reactive components without the conveyor means being blocked. The metering of the stored components is also effected into the mixer element. The utilisation of a mechanically driven, rotating mixer device has the disadvantage that either the change from one composition of the mixture to the next takes a long time since a large amount of the new mixture must be continuously fed through the mixer device for rinsing or the mixer device needs to be dismounted for each change of the composition to be replaced by a cleaned one. Such devices are therefore unsuitable for rapidly changing plastics mixtures.

The EP 0 904 927 A1 describes means for introducing a reactive system composed of at least two components, particularly liquid silicone rubber, into a mould, the components being supplied to a mixer means by a volumetric metering unit comprising a metering piston and the obtained mixture being conveyed into an injection cylinder. In this case the metering unit is integrated in the injection moulding machine. It is essential in this known device that a metering unit comprising a metering piston is provided for each component and that the combination of the flows of the components is carried out in a dynamic mixer. The problem of the rapid production of mouldings having different compositions is not mentioned in said document. The EP 0 904 927 further particularly refers to reactive liquid silicone mixtures radically differing from thermoplastics in their rheologic and thermodynamic properties.

From the U.S. Pat. No. 5,688,462 an injection moulding process is known in which a static mixer is used. The mixer is disposed inside the tool directly upstream of the mould inlet to avoid a thermally induced inhomogeneity of the smelt. A rapid change of products is impossible with said device due to the missing metering and supply means.

From the DE 2 329 966 a device for preparing products of thermoplastics is known in which a static mixer at the inlet of which a second component is introduced is connected to a plasticizer, for example a screw extruder. Said device is substantially an extruder comprising a mixer means and not an injection moulding machine which, on the other hand, is required for an integrated production of mouldings.

From the U.S. Pat. No. 4,255,367 a method for preparing injection moulded products is known in which additives are introduced into the smelt flow in the flow direction between the injection means comprising a storage cylinder including a piston and the mixer element during the injection of the molten plastic. Due to the zoned addition of additives an intentionally inhomogenous moulding having a kind of core/shell structure is prepared. Such a method is, for example, absolutely unsuitable for the development of formulas in which particularly a uniform composition of the specimen is essential.

In the DE 19 902 990 a method and an apparatus are described in which a plastic material and an additive are rough mixed in a screw push plasticizer unit, mixed in a dynamic mixer and then injected into the cavity of an injection moulding tool. A drawback here is that the mixing process is very slow in such plasticizer units having a mixing effect; in addition the cleaning procedures are considerable in case of a screw push plasticizer unit so that the period of time required for the mixing and injecting process including the cleaning cycles in case of a change of the mixtures may be in a range of up to several hours.

Similar problems occurring in connection with the rapid preparation of homogenous mixtures having changing compositions are, for example, also encountered in the development of cosmetic compositions or in food technology, e.g. in the development of snack food compositions from pastes or pastry on the basis of starchy products with varying additives or changing compositions.

It is an object of the invention to provide methods and devices for the, as compared to the state of the art, considerably faster and more economic preparation of homogenous or semi-homogenous mixtures from viscous or pasty multi-component systems, particularly from various plastic systems, and for preparing and possibly for handling and testing mouldings made from such mixtures in which an easy and rapid change of the composition is possible, preferably while minimising the material consumption.

Further it should be possible to subject the mixtures or mouldings obtained to one or more tests after their preparation, particularly within the framework of an overall process comprising the preparation of mixtures and/or mouldings and the testing of the mixtures or mouldings, alternatively after their intermediate storage or in a process-linked manner.

The object is solved by the features of the independent claims. The dependent claims relate to preferred embodiments of the concept of the invention.

Plastics mixtures for the preparation of mouldings are generally homogenous, while mixtures may only be semi-homogenous, i.e. not ideally homogenous, in case of blends, the homogeneity, however, being sufficient for the production and testing of mouldings.

According to the method of the invention for the rapid preparation of homogenous or semi-homogenous mixtures having given and, in particular, frequently changing compositions and possibly of mouldings produced therefrom multi-component systems are used which comprise two or more viscous or pasty fluids (component system A) or one or more viscous or pasty fluids and one or more additives (component system B). The mixture is obtained by introducing predetermined quantity ratios of the components of the component system A or B into a rough mixer means such as, for example, an injection unit, in which the viscous or pasty state of the component system remains unchanged. The component system obtained in the rough mixer is mixed in a mixer means to obtain a homogenous or semi-homogenous mixture from which then mouldings can be prepared.

In its most general form the method according to the invention for the rapid preparation of homogenous or semi-homogenous mixtures having predetermined compositions of component systems
(A) of two or more viscous or pasty fluids or
(B) of one or more viscous or pasty fluids and one or more additives comprises the following process steps in the given sequence:
(I) generation of a flow having a constant and selectable throughput of at least one of the viscous or pasty fluids of the component system (A or B) (primary flow),
(II) introduction of the other components of the component system (A or B) in the form of one or more secondary flows having a constant and selectable throughput into the primary flow on substantially the same axial level with respect to a plane transverse to the flow direction of the primary flow so that the flow directions of the secondary flows are approximately parallel to the flow direction of the primary flow
   while forming a rough mixture flow of the components of the component system (A or B) having a substantially uniform overall composition corresponding to the predetermined composition within volume elements extending across the cross section of the rough mixture flow, and
(III) supply of a predetermined and selectable volume of the rough mixture flow through a mixer means having a radial mixing effect while obtaining the homogenous or semi-homogenous mixture of the component system (A or B).

The primary flow may, correspondingly, consist of a plurality of components and be a rough mixture itself.

The process step III may preferably be followed by the following process step IV:
(IV) preparation of one or more mouldings from the obtained homogenous or semihomogenous mixture.

In process step II the introduction of the secondary flows into the primary flow or the establishment of a contact between the two flows creates a rough mixture structure which can be illustrated by comparison with a strand of tooth paste with coloured stripes on the circumference, the primary flow corresponding to the strand of tooth paste and the secondary flows to the coloured stripes. Each volume element (disk) extending across the cross section of said rough mixture structure already has a substantially uniform composition in the axial direction; in the radial direction, however, only little or no homogeneity exists depending on the relative quantity ratios of the components. In the downstream mixer device having a radial mixing effect the rough mixture is radially homogenised.

During the radial mixing process therefore the “tooth paste stripes” will vanish and an all over three-dimensionally homogenous or semi-homogenous mixture will be formed from which mouldings can be produced.

In the method according to the invention the flow direction advantageously remains the unchanged throughout the process steps I, II and III as well as the process step IV, if it is carried out.

This method for preparing a mixture can be carried out continuously.

If a moulding production follows as process step IV the method generally becomes altogether discontinuous unless the moulding production is a continuous extrusion.

However, the method can be carried out continuously up to the preparation of the mixtures in the process steps II or II. Further devices for an intermediate storage or buffering of a continuously generated mixture flow which enable the discontinuous production of mouldings from a continuously arriving mixture flow, e.g. by injection moulding, are known to those skilled in the art.

It may, however, be advantageous to effect a supply of the rough mixture flow by the mixer means in a flow direction opposed to the flow direction of the primary flow in process step I and the rough mixture flow in process step II in process step III and possibly also in process step IV.

Said method is discontinuous due to the reversal of the flow direction.

If such a method is used the components of the component system are introduced, in predetermined quantity ratios, into an injection unit in which the viscous or pasty state of the component system remains unchanged, homogenised or semi-homogenised in a downstream mixer device, after which mouldings can be produced from the mixture. This basic method is known from the document DE 19 902 990 mentioned above.

A first embodiment of the method according to the invention including a reversal of the flow direction in process step III and possibly also IV has the following features:
use of an injection unit substantially consisting of a cylinder and piston which can be axially shifted therein,
simultaneous insertion of the components of the component system (A or B) into a volume element extending across the radial cross section of the cylinder at the outlet side end of the cylinder of the injection unit above the piston while, at the same time, the piston is returned from an upper stroke position to a lower stroke position, and preparation of a rough mixture of the components of the component system (A or B) having a substantially uniform overall composition corresponding to the predetermined composition within volume elements extending across the radial cross section of the cylinder,
feeding the rough mixture through the mixer means by advancing the piston from the lower stroke position to an upper stroke position, and
homogenisation or semi-homogenisation of the rough mixture in a mixer means having a radial mixing effect, particularly in a static mixer device.

The production of mouldings may follow.

In a second embodiment of the method according to the invention including a reversal of the flow direction the introduction of the components of the component system into the cylinder of the injection unit is effected above the piston while at the same time the piston is returned from its upper stroke position to a lower stroke position and a rough mixture of the components of the component system is formed the composition of which corresponds to the predetermined overall composition, after which the rough mixture is homogenised in a mixer means having a radial and an axial mixing effect. Such a mixer means may be a dynamic mixer means, it is however, preferably a static mixer.

According to the first of these embodiments the components of the component system are introduced into one and the same volume element on the outlet side end of the cylinder when the piston is returned, preferably through inlets in the cylinder which are disposed on the same axial level.

In this case the piston may be pressed into the lower stroke position by the pressure building up due to the introduction of the components above the piston. This process can also be supported by an active retraction of the piston by its drive unit.

By introducing the components on preferably approximately the same axial level of the cylinder a rough mixture structure which again may be illustrated by comparison with a strand of tooth paste having coloured stripes is formed when the piston is retracted.

According to the above-mentioned second embodiment of the method of the invention including a reversal of the flow directions the components of the component system do not imperatively need to be introduced into the cylinder in the same volume element or on approximately the same axial level. The axial position of the inlets of the cylinder may therefore be principally different for the different components introduced since the rough mixture formed is in this case homogenised or semi-homogenised by the mixer means having an axial and a radial mixing effect.

According to this embodiment of the method of the invention it may be advantageous to introduce one or more components of the component system into the cylinder on different axial levels, particularly for reasons of space, if the corresponding supply means, valves, metering means, etc. or their ports on the cylinder are bulky and require a lot of space or if a star shaped radial arrangement, seen in the axial direction, of said means on the cylinder is to be avoided.

According to both methods including a reversal of the flow direction the homogenisation of the component system is effected by moving the piston forward so that the content of the cylinder is pressed through the mixer means.

If a moulding tool is connected, filling is advantageously effected through a nozzle formed with or without a hot channel. The downstream moulding tool is preferably an injection moulding tool, again with or without a hot channel, and advantageously comprises more than one cavity to enable the production of a plurality of mouldings, possibly in different shapes.

Preferably the secondary flows are generally introduced into the primary flow in the radial direction.

According to the method of the invention preferably at least one of the viscous or pasty fluids is molten plastic, for example a plastomer or a thermoplastic elastomer or another conveyable plastic material advantageously forming a polymer matrix. The components, however, may also be suitable for the production of polymer blends, cosmetic products (e.g. lipsticks, skin cream, etc.) or pharmaceutical products (e.g. suppositories), or they may be food components, particularly for pastry (e.g. bread, cake) or components for the production of toys (e.g. plasticine).

The mixture obtained after process step III or possibly after a following process step IV may be subjected to a reaction in a reactor or a reaction section. An advantageous application of this method is the cooking extrusion of starch-containing milled grain products which is particularly used for the production of instant flour, instant semolina or snack food. The mouldings may, in this case, be flour, semolina or snack products. The cooking extruder may here also have the function of a mixer means which, in this case, has a radial and an axial mixing effect.

According to the method of the invention preferably at least one of the components of the component system is a matrix material, particularly a molten plastic material, and at least one of the other components is an additive. Typical additives are, for example, fillers, UV stabilisers, oxidation stabilisers, catalysers, flow and demoulding agents, lubricants, polymer components, flame-retardants, colouring agents, pigments, reactive components, etc. of which one or more components are preferably introduced into the primary flow with one or more of the mentioned viscous or pasty fluids which are preferably present in the form of e.g. liquids, solutions, dispersions, emulsions, powders, granulates, smelts or fibres. Practically one or more of the components mentioned above are used for the primary flow and/or the secondary flow in rough mixed form, particularly as pre-blends.

The rough mixer means or the cylinder is preferably formed so that, depending on the requirements, a changing number of supply means for secondary flows may be connected to it by exchangeable connections, e.g. bayonet couplings. Depending on the requirements different types of supply means, like, for example, single or double screw extruders, may be connectable to the rough mixer means.

In the method according to the invention therefore principally any number of secondary flows may be selectively introduced into the primary flow.

In to a particularly preferred embodiment of the method one or more mixtures are introduced into the primary flow as secondary flows which are themselves obtained after the process step II or the process step III according to the method of the invention. Using this method particularly many potential mixture combinations and particularly homogenous final mixtures or mouldings of a particularly high quality can be obtained.

The method according to the invention is advantageously carried out in a closed system, particularly the process steps I to III or I to IV.

In this case, it is generally advantageous if one, several or all introducing means for secondary flows or supply means comprise a metering means by means of which the corresponding components of the component system may be metered in while being introduced into the cylinder to enable the setting of absolute quantities or predetermined quantity ratios of the components. The components of the component system are preferably introduced into the cylinder in the radial direction.

In case of a discontinuous method the volume of the supply means and/or the rough mixer means used for moulding in the production of mouldings or the stroke volume of the cylinder of the injection unit is preferably selected so that it corresponds to one or more fillings of the moulding tool which may have a plurality of identical or differing cavities in a per se known manner. In addition it is particularly advantageous that the devices used have as little dead volume as possible, i.e. that, if possible, the total content of the devices can be used for the preparation of mixtures or mouldings, except for the dead volume of the mixer means and the moulding tool.

The preparation of the moulding or the mouldings is advantageously carried out in a paced manner, wherein
the process steps I to III are carried out in a mixture preparation stroke and
mouldings are prepared from the homogenous or semi-homogenous mixture in one or more following moulding strokes,
   after which the above sequence of a mixture preparation stroke and one or more following forming strokes can be repeated as often as desired.

In case of shaping by injection moulding the process step III and possibly the process step IV as well are preferably carried out with a higher mass or volume speed or with a higher throughput than the process steps I and II.

If the composition of the of the component system is changed or another component system is to be used, the dead volume of the cylinder and the mixer means and possibly also a nozzle used for moulding or the moulding tool need to be rinsed with a component system having another composition after one or more cycles of the production of mouldings from the one component system. The component system used for rinsing may then also be used to produce mouldings. In this way residues of a previous composition will be rapidly removed from the system.

According to another embodiment e.g. cylindrical or rectangular strands or foil ribbons are formed by continuous extruding of the homogenised or semi-homogenised component system, from which then the actual shaped bodies can be punched or cut.

With the method according to the invention described above preferably mouldings are prepared which serve as specimen for the determination of material-specific properties, i.e. of characteristics of the respective component system to be tested, e.g. of plastics mixtures. The method according to the invention, however, is of course also suitable as a production method for mixtures or mouldings.

The method according to the invention is preferably carried out by controlling the throughput of the primary flow and the throughputs of the secondary flows by means of a control means. This is preferably carried out so that the introduction and supply of one, several or all components of the component system is controlled depending on the type, the metered in amount and/or the metering rate. This also applies to the modified method including a reversal of the flow direction. Furthermore the production of mouldings from the obtained mixtures is preferably controlled as well.

The method according to the invention can preferably also be consolidated method comprising the production as well as the handling and testing of mouldings. In this case one or more of the following steps are carried out after process step IV:
(a) sequential and/or parallel supply of the mouldings to a conveying system, possibly including the retrieval from a magazine;
(b) conveying the mouldings to one or more testing means;
(c) implementation of the corresponding test(s) in one or more testing means;
(d) sequential or parallel removal of the mouldings or products prepared therefrom from the testing means and insertion into a magazine, an archive storage or a garbage container after the implementation of the test(s).

The consolidated method is preferably integrated into one single process comprising the preparation of mouldings as well as handling and testing the mouldings and preferably also the recording and processing of the test results.

One or several or all steps of the method according to the invention including the consolidated method described above are preferably carried out or controlled using central data collection and processing, particularly using a computer system or a micro processor system. The control may also be effected using programmable logic control.

In this way, for example one or several or all conveying operations, particularly in steps (a), (b) and/or (d), are controlled by one control means. The same applies to the tests in step (c); said tests and/or the collecting, processing and/or transfer and/or output of test results are preferably also controlled by one controller.

An advantageous embodiment of the above consolidated method is characterised by the collection, processing and/or transfer of test results in or after step (c).

When the mouldings are moved to a plurality of testing means in step (b) the transportation may be effected sequentially and/or in parallel. The same applies to the tests in step (c).

In general the specific moulding type provided for the respective test is to be supplied to the various testing means.

Here either an automatic or a manual exchange of the moulding tool or the use of a moulding tool having several cavities corresponding to the mouldings to be prepared is required for the production of the mouldings; a central control of the partial processes or of the complete process being particularly suitable for such cases.

When the tests mentioned above are carried out, the mouldings are tested for one or more of their chemical, particularly their polymer chemical, physical, biochemical, biological, pharmacological, organoleptic, haptic or other relevant properties. The test may, however, also relate to one or more of the mechanical, polymer physical, optic, electric or magnetic properties.

Another aspect of the present invention is the allocation of test results to the composition of the tested mouldings. Within the scope of the invention said allocation is preferably also carried out by a control means or a data processing device.

If the allocation can be effected in a simple and univalent manner, particularly in case of test series including a small number of different mouldings or specimen, a mathematical correlation is usually not required.

However, if a large number of mouldings having different compositions are produced within relatively short periods of time in the range of minutes to hours and one or more of their properties are to be tested large amounts of data are to be handled from which the influence of the varying variables and the parameters respectively kept constant on the test results can no longer determined or derived in a simple and univalent manner in many cases. That holds true particularly for the production of plastic mouldings since here numerous combinations of process variables and process parameters are feasible and frequently need to be implemented in practise.

For such cases the scope of the invention provides for the utilisation of mathematical correlation methods and preferably for their implementation in a control means or data processing device which results in a correlation between the process variables, process parameters and moulding compositions on the one hand and one or more properties of the mouldings on the other.

Typical process variables or process parameters, i.e. values which are varied or kept constant, are, for example, the composition of the component system used, the quantity rations of the components, the processing temperatures, the type and speed of the homogenisation, the duration of the storage of specimen before the test, the heating and cooling time, the duration of rinsing operations and the quantities of the subsequent component system used therefore, etc.

Apart from various statistical evaluations a preferred method is the determination of such correlations with the aid of a neural network. Such evaluation and correlation methods are per se known to those skilled in the art so that they do not need to be discussed in detail.

With such evaluation systems trends relating to product properties can be identified even in series experiments within a relatively short period of time as compared to conventional methods.

The invention further relates to a device for the rapid preparation of homogenous or quasi-homogenous mixtures having a predetermined composition of component systems
(A) of two or more viscous or pasty fluids or
(B) one or more viscous or pasty fluids and one or more additives, particularly for the implementation of the method according to the invention comprising
   a supply and rough mixer means including
      a conveying means having one or more inlets for at least one of the viscous or pasty fluids of the component systems (A or B) as a material for a primary flow which can supply the material as a primary flow with a constant and selectable throughput in a predetermined flow direction, and
      a rough mixer means preferably disposed on the downstream end of the conveying means and comprising
         a main inlet for the primary flow from the conveying means,
         one or more inlets for the other components of the component system (A or B) disposed substantially in the same plane transverse to the flow direction of the primary flow preferably positioned near the main inlet or at the main inlet, and
         introduction means connected to the inlets and formed so that the other components of the component system (A or □) are brought into contact with and/or introduced into the primary flow in the form of one or more secondary flows, as well as
   mixer means having a radial mixing effect the inlet of which is disposed at the outlet of the rough mixer means and at the outlet of which the homogenous or semi-homogenous mixture of the component system (A or B) is discharged.

For the preparation of mouldings the device may further include a moulding tool connected or connectable to the output of the mixer means.

According to one embodiment the device is characterised in that
the main inlet of the rough mixer means for the primary flow is disposed on the outlet side of the rough mixer means on substantially the same axial level as the inlets for the secondary flows,
the rough mixer means comprises an own conveyor means having two opposed, reversible supply directions and can be filled with the material of the primary flow and the secondary flow(s) in the first flow direction, at which occasion the primary flow contacts the secondary flows, while in the second flow direction the rough mixture of the components of the component system (A or B) formed in the rough mixer means can be conveyed into or through the mixer means.

In this device the conveying means of the rough mixer means substantially consists of a piston disposed in a cylinder provided therein and a piston drive (injection unit), the inlets for the secondary flows being positioned on the outlet side end of the cylinder opening into a volume element VE, the piston being axially reciprocable within the cylinder, and a rough mixture of the components of the component system being formed from the primary flow and the secondary flow(s) flowing in a first flow direction when the piston is returned into a lower stroke position which rough mixture can be conveyed into or through the mixer device when the piston is then advanced into an upper stroke position.

In such a device the flow direction of the conveyer means and/or the flow direction of the rough mixer means is reversible.

According to another embodiment the inlets for the secondary flows open at the outlet side end of the cylinder and/or at a position axially spaced therefrom, the mixer means being a mixer means having a radial and an axial mixing effect.

In the devices according to the invention described above the inlets of the rough mixer means having the cylindrical basic shape advantageously open in a substantially radial direction. According to the first embodiment of the device of the invention a rough mixture is prepared which has a substantially uniform composition within the “disk-shaped” volume elements VEᵢ extending across the radial cross section of the cylindrical rough mixer means which is virtually independent of their axial height. Said rough mixed structure which was illustrated above by comparison with the coloured stripes on a strand of tooth paste and which is formed when the piston is returned while the stroke volume in the cylinder is filled, is best prepared by introducing the components of the component system to be processed into one and the same volume element VE of the cylinder at the outlet side end of the cylinder, i.e. at the same or substantially the same axial level, via the various supply means.

The device according to the second embodiment is provided with a mixer means having an axial and a radial mixing effect. In this case the mixer means produces a homogenous or semi-homogenous mixture from which then mouldings are produced irrespective of the type and structure of the rough mixture prepared in the cylinder of the injection unit. According to this second embodiment of the device the inlets of the supply means may correspondingly be disposed in the rough mixer axially level and/or on different axial levels.

Preferably the supply means substantially consists of a unit comprising a plasticizer screw and a piston.

According to an advantageous embodiment the rough mixer is formed
as a substantially cylindrical element provided with one or more orifices or nozzles opening into the primary flow for introducing secondary flows through the inlets at the circumference, or
as a shutter-like plate or disk disposed perpendicular to the flow direction of the primary flow through and/or around which the primary flow can flow, said plate or disk comprising openings or nozzles opening into the primary flow axially in the flow direction or in a direction vertical to the flow direction of the primary flow downstream of the plate or disk for introducing secondary flows through the inlets or
as a preferably substantially rotationally symmetric flow body disposed in the primary flow, the primary flow flowing around said flow body, and provided with openings or nozzles opening into the primary flow downstream of the flow body for introducing secondary flows through the inlets.

Preferably the moulding tool is an injection moulding tool. It may, however, also be a continuous casting tool, and the strand produced may be cut to form shaped bodies by a punching or cutting means.

In the devices according to the invention the means by which the primary flow is generated and introduced into the device as well as the introducing means for secondary flows are either suitable for metering in the respective introduced flows of substances or they are provided with a metering device. Such means and metering devices are known to those skilled in the art. Typical supply means which also have a metering function are extruders; the metering function may be obtained by switching the drive or controlling the rotational speed.

However, any other, per se known metering means may be used within the scope of the invention, e.g. gear pumps, valves, shutters, sliders, piston metering devices and the like.

With the metering devices the throughputs or the absolute amounts of the individual components and thus their quantity ratio can be set so that certain predetermined compositions or formulas can be realised in a particularly simple manner.

The devices according to the invention for the production of mouldings may further include one or more testing means for testing the properties of the prepared mouldings which are arranged downstream of the moulding tool or a retrieval and magazine system or combined with one or more testing means.

The device according to the invention is preferably a modular construction, the supply means, the rough mixer means and the mixer means as well as possibly the moulding tool being formed as modules which are preferably detachably connected to each other by means of quick-action fastenings.

The conveying, storage and testing equipment may also be modular.

According to particularly preferred embodiments the device according to the invention comprises one or more introduction means for secondary flows and/or conveying means for the primary flow which are devices according to the invention for the preparation of corresponding mixtures of components.

The device according to the invention for the preparation of mouldings may advantageously comprise one or more magazines for the storage or intermediate storage of mouldings as well as a conveying system.

The device may further advantageously include a magazine system comprising one or more magazines and their conveying, signalling or data links in which the prepared mouldings can be stored or temporarily stored.

A particularly preferred embodiment of the device according to the invention comprises
a conveying system and
one or more testing means for testing the properties of the mouldings
   wherein the conveying system can carry out at least one of the following functions:
(i) gathering or obtaining mouldings from a moulding tool, a cutting or punching device, a magazine system, a magazine and/or an archive storage,
(ii) conveying mouldings to one or more testing means,
(iii) conveying mouldings from one or more testing means to one or more other testing means,
(iv) conveying mouldings from one or more testing means to a magazine system, a magazine, an archive storage and/or a garbage container,
(v) conveying mouldings from one magazine system or magazine to another magazine system or magazine,
(vi) application of a code to mouldings or magazines and/or reading codes on mouldings or magazines and controlling the conveying operations depending on the codes,
(vii) conveying magazines in which mouldings can be stored to discharging or returning locations.

One or more of the functions (i) to (vii) may be carried out sequentially and/or in parallel.

The device for handling and possibly testing mouldings may comprise one or more magazines in which mouldings may be stored or temporarily stored.

Controllable and particularly centrally controllable conveyor systems as well as testing systems are per se known to those skilled in the art.

The conveyor system of the handling equipment according to the invention may advantageously be formed as a conveyor belt system, trolley system, moving carpet system, rail track system, circulating system or robot system.

Circulating systems have the advantage of a simple mechanical construction and a simple control.

According to a particularly preferred embodiment of the invention the device of the invention for preparing mouldings and specimen comprising the device for handling and testing the mouldings are integrated so that they form an consolidated device. By combining the production and testing of mouldings including the result evaluation test results can be obtained in an extremely economic and at the same time timesaving way.

These advantages are of particular importance when test series are to be carried out on numerous mouldings having frequently changing compositions.

The coding systems are not subject to limitations within the scope of the invention. Therefore the codes may be holographic codes, barcodes, magnetic codes, transponder codes, chip codes, colour codes or shape codes.

Within the scope of the invention encoding the mouldings as well as the magazine locations and testing equipment by allocating or applying a code is not compulsory.

According to a simple embodiment of the device according to the invention the addresses to which and from which specified mouldings are to be supplied and collected (delivery locations, gathering locations, return positions) may be derived simply from a predetermined order in which specified mouldings are produced or the order of the delivery locations, gathering locations and return positions. In such cases the allocation of specified mouldings to specified addresses results specifically from the process flow itself without any individual encoding being required. In practise such allocations are advantageously generated by a controller and possibly transmitted via data links between the controller and corresponding means such as testing equipment or magazines. Said sequence-depending allocations may be stored allocations.

The devices according to the invention preferably include a control means controlling one or several or all of the functions of the device. It may comprise an input means for inputting data and an output means.

The control means may in principle be designed so that it is signal and data linked to the controlled elements of the device or elements of the device to be controlled or corresponding actuators. Said connection may be established via lines or without lines and may, in the latter case, be a radio link, such as a Bluetooth link. The signal or data links may be designed so that signals or data can be transmitted in both directions to enable, for example, a back indication from a controlled element of the device to the control means indicating that an operation was carried out.

The control means is advantageously designed so that it is capable of controlling the respective consolidated process, at least, however, one of the following items or functions:
the conveying means,
the rough mixer means,
the piston drives or driving units,
the introducing means for the secondary flows or their metering means,
the composition of the primary flow and/or of the secondary flows,
the mixer means,
the half moulds or the tool drive,
a storage system,
one or more magazines,
a conveyor system,
testing means,
an encoder,
encoding the mouldings and gathering locations and/or delivery locations of magazines,
detection, evaluation, processing, storage, transfer and/or output of test results.

The control means is preferably a computer, particularly a micro computer or a computer network including a mainframe computer.

The control means may, however, as well be a programmable logic control or include such a control.

The control means preferably has an encoding function as well. For each moulding produced the conveying path up to the testing means and from there to other testing means or to magazines or from magazines to other delivery or return locations are encoded. This embodiment is particularly advantageous since generally a specified type of moulding is required for each test which can be specifically produced, conveyed and possibly even stored.

The encoding together with corresponding programs enables the localisation and identification of mouldings and the allocation of test results to individual mouldings.

The control means may advantageously include a neural network which can be used to allocate e.g. test results of the composition of the respective moulding and/or process conditions so that after programming result predictions for compositions can be made and therefore the corresponding experiments can be omitted.

Control means and encoding systems are known to those skilled in the art so that no detailed explanation is required.

Within the scope of the invention it is of course possible to manually control individual steps or sequences of the process or even all of the respective process and to manually operate the corresponding parts of the device, e.g. the tool drive or the testing equipment.

Embodiments of the invention will be explained in detail below with reference to the drawings in which

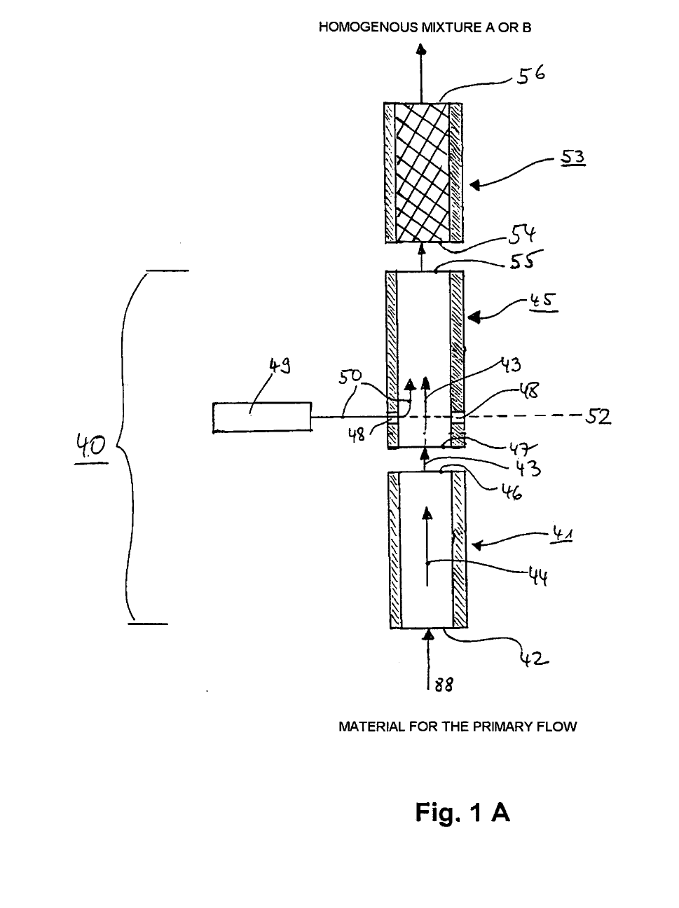

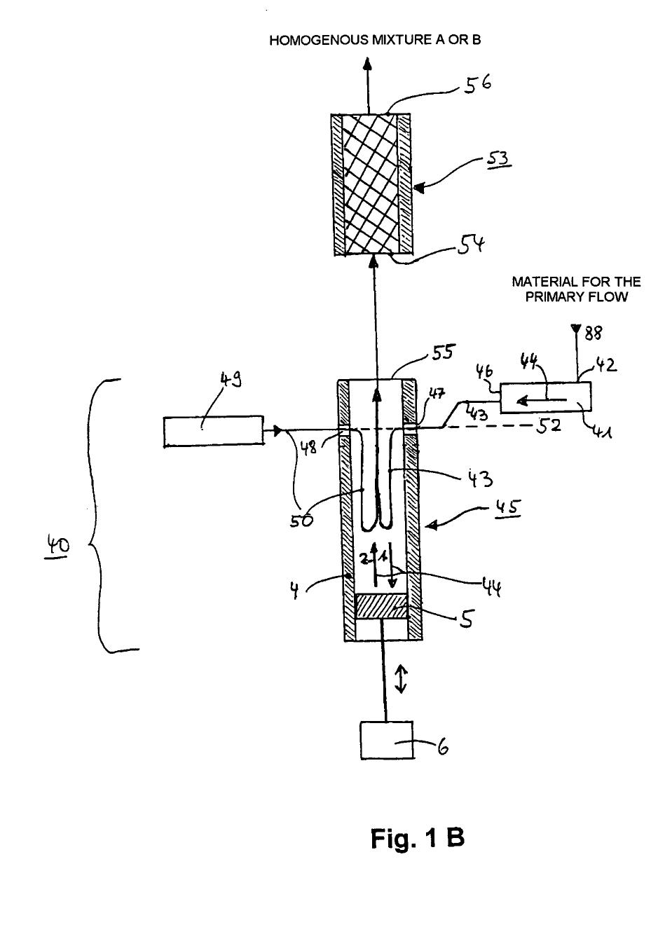

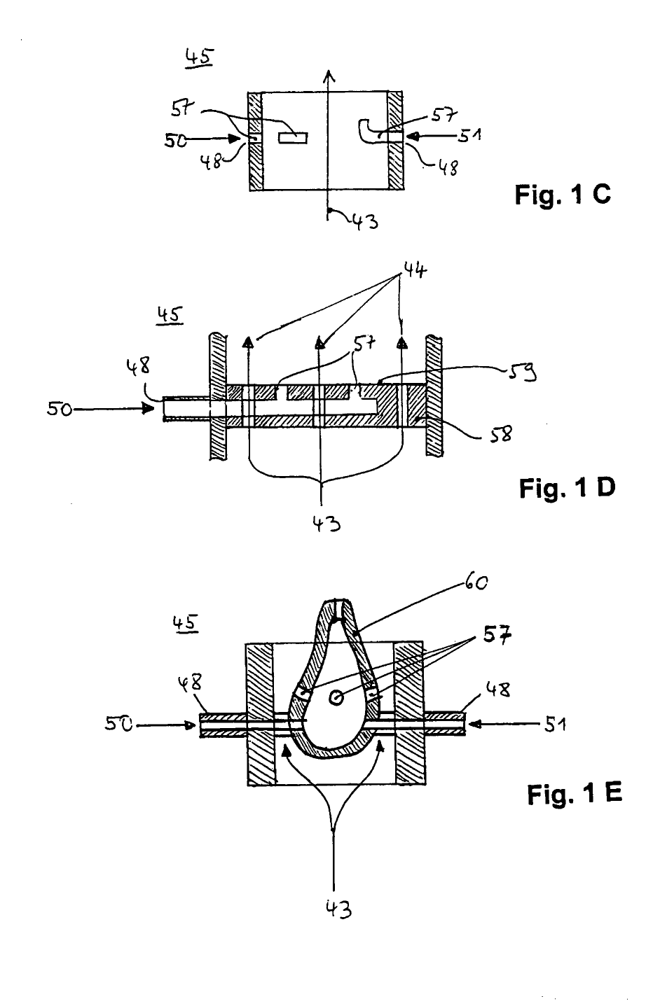

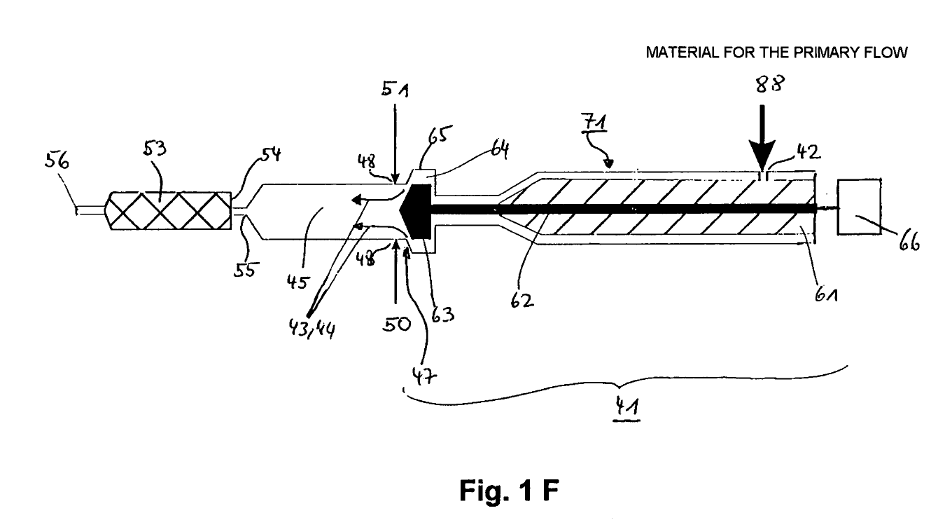

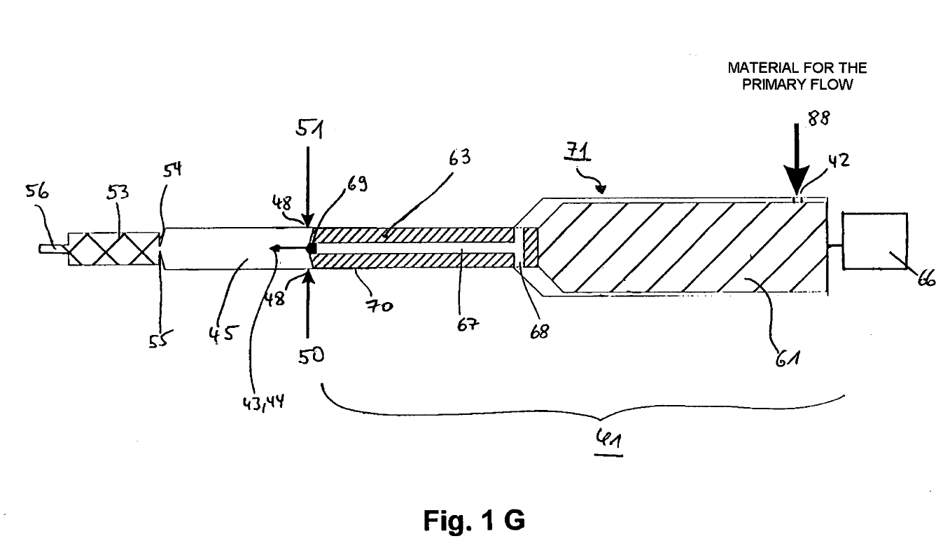

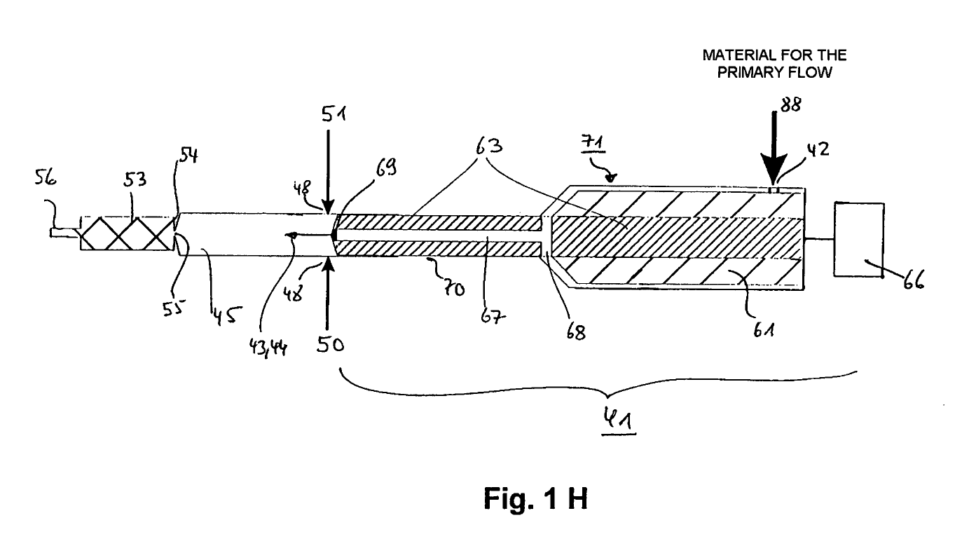

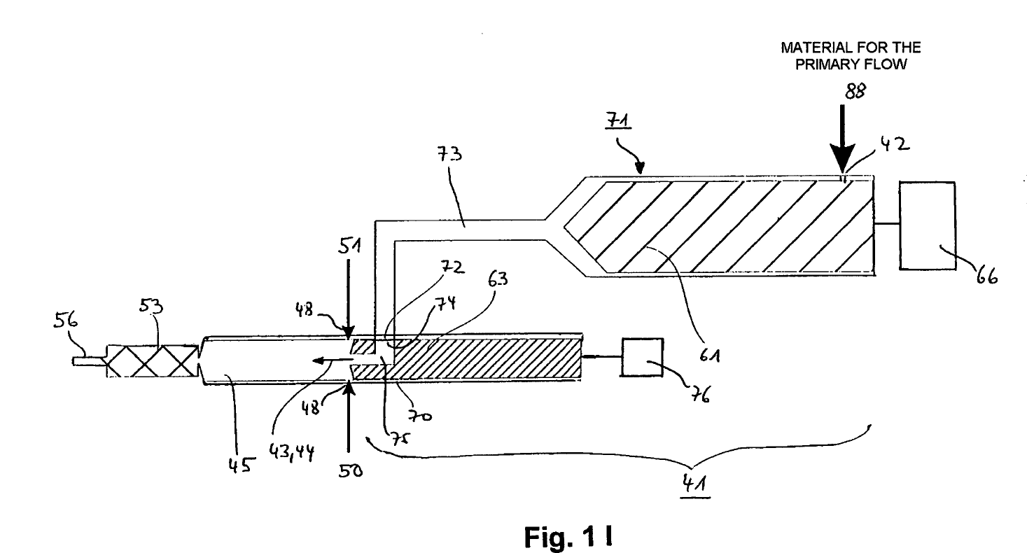

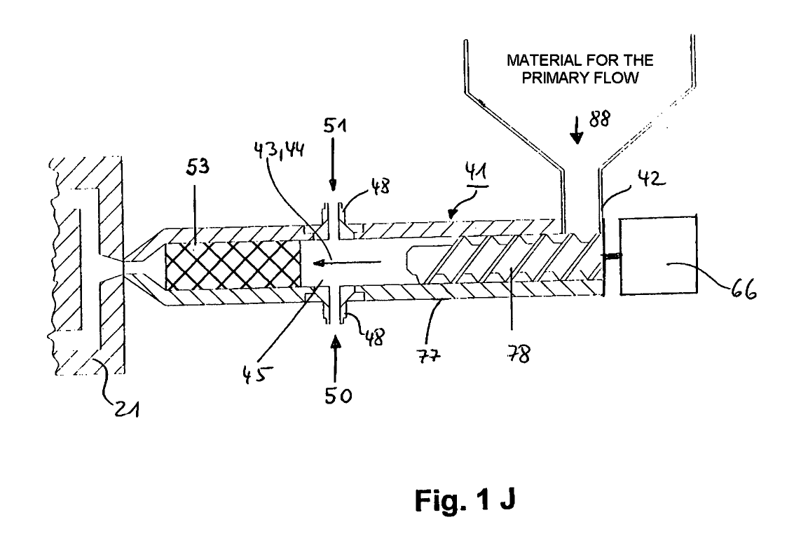

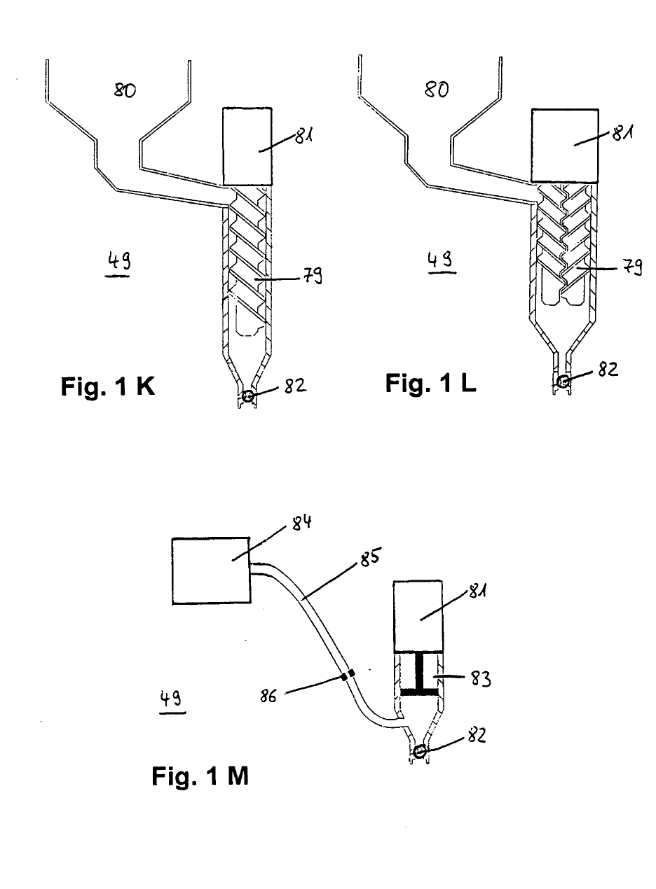

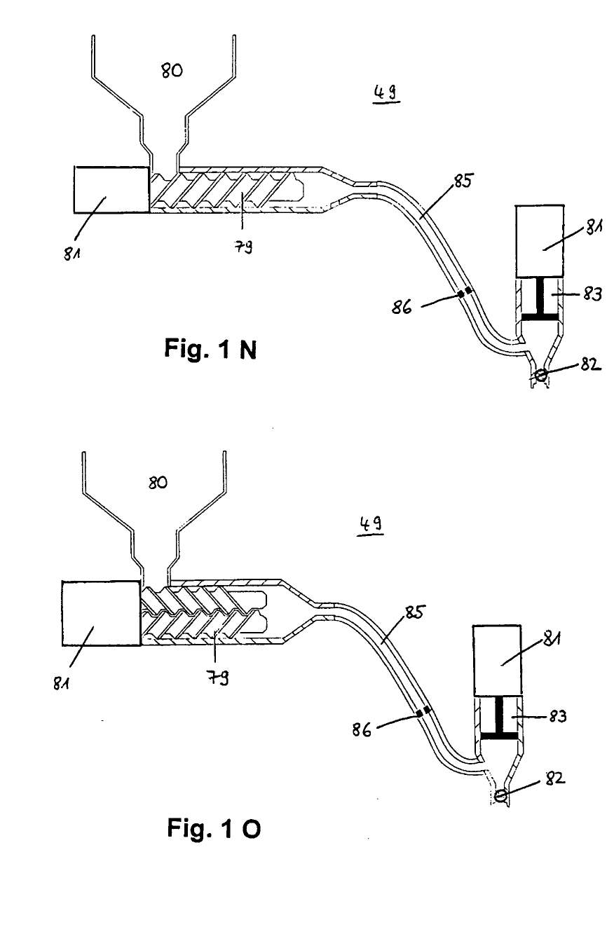

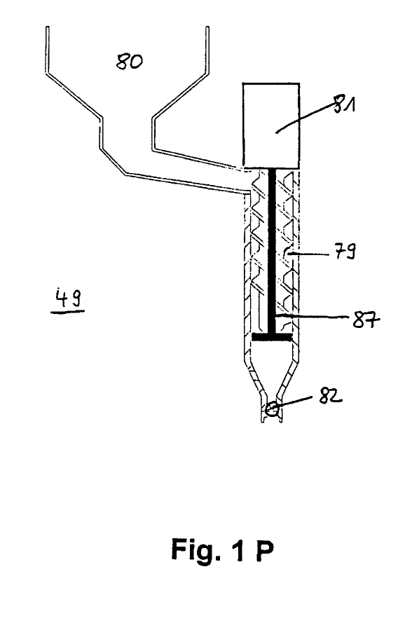

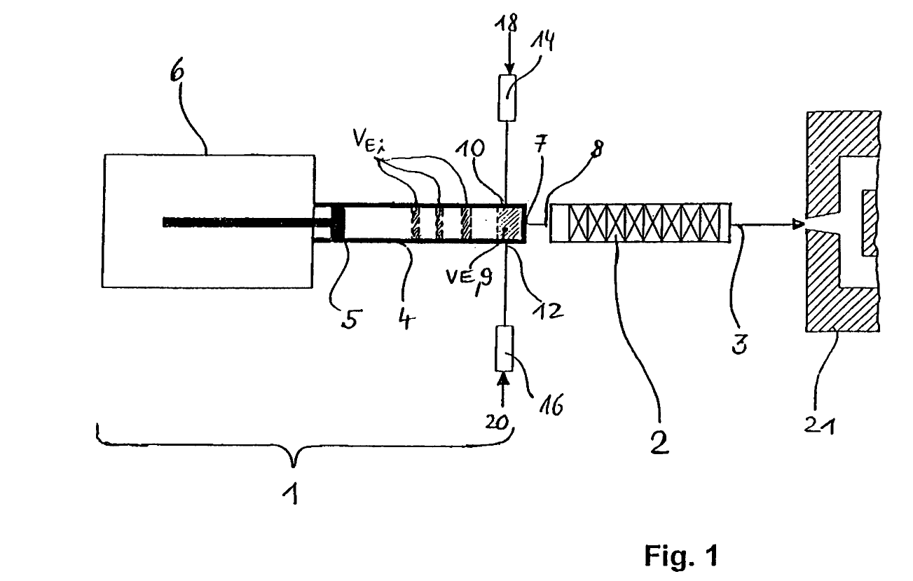

FIGS. 1A, 1B are schematic views of devices according to the invention for preparing homogenous mixtures;

FIGS. 1C, 1D, 1E show various embodiments of rough mixers according to the invention;

FIGS. 1F to 1J show various embodiments of devices according to the invention for the preparation of homogenous mixtures or for the production mouldings (FIG. 1J);

FIGS. 1K to 1P show various embodiments of introduction means for secondary flows;

FIG. 1 is a schematic view of another embodiment of a device according to the invention for the production of mouldings;

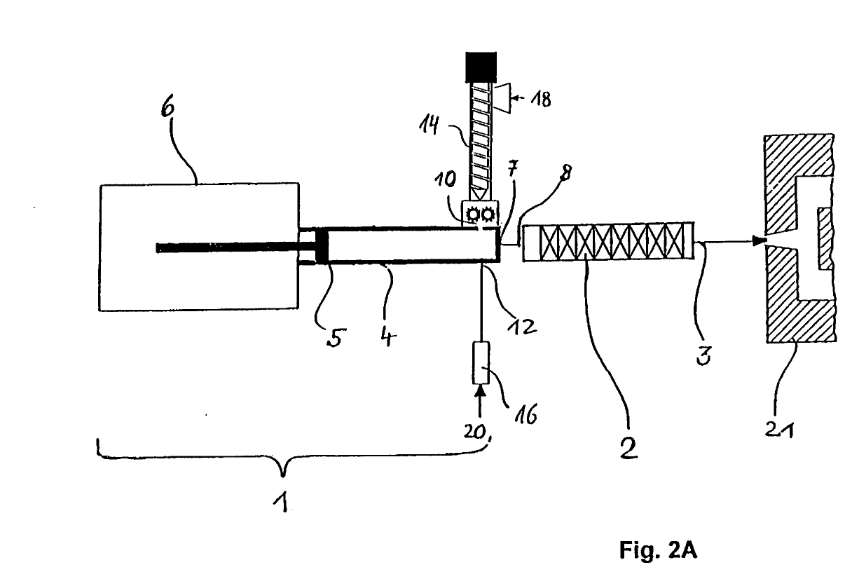

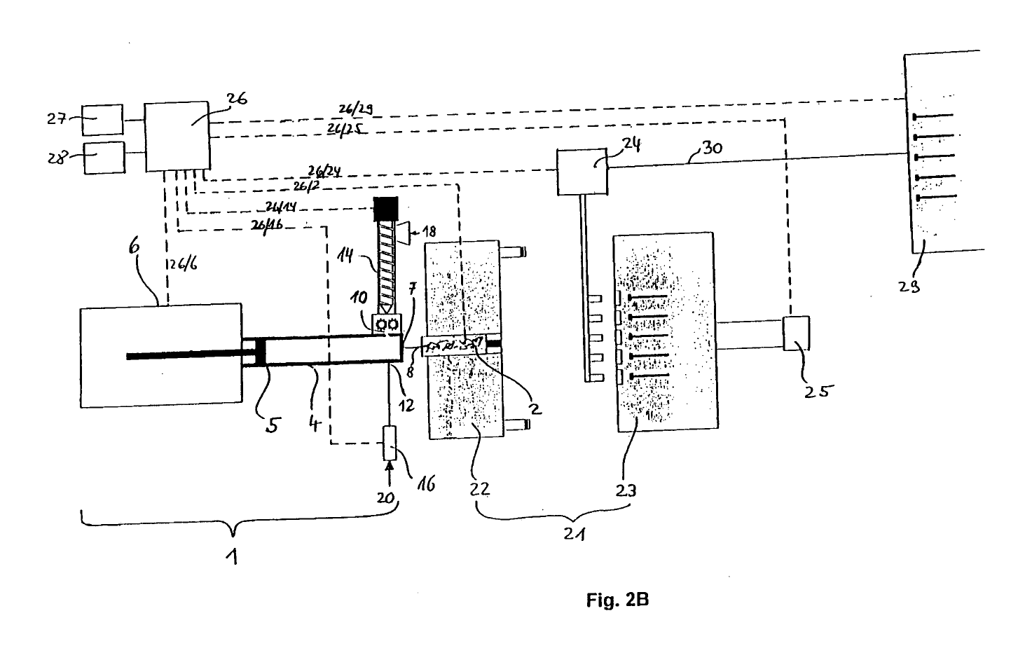

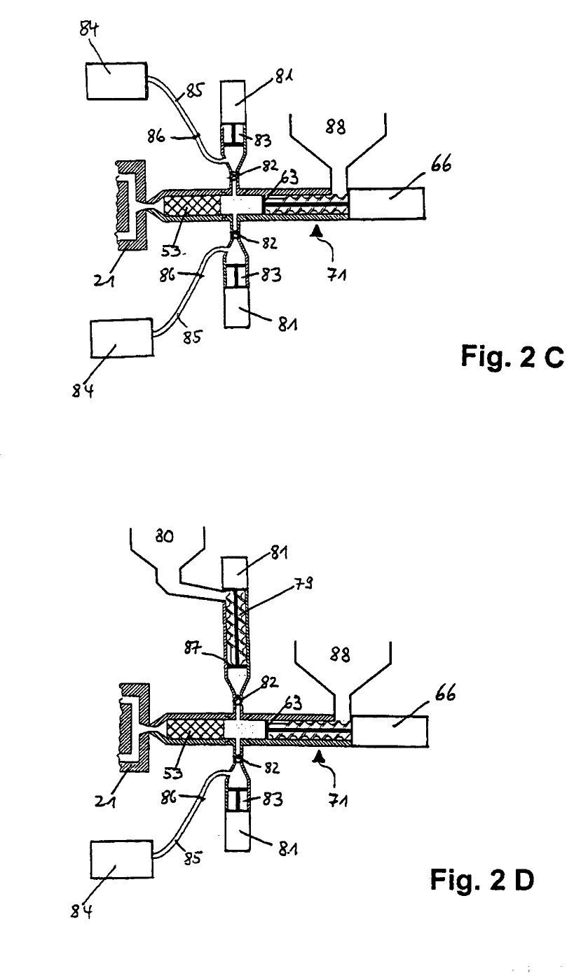

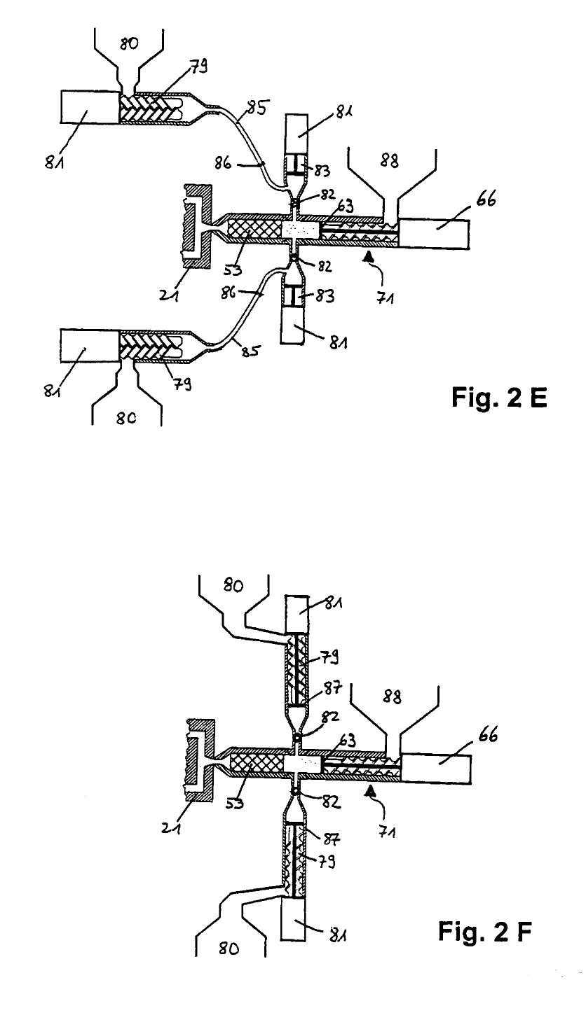

FIG. 2A is a schematic view of another embodiment of a device according to the invention for the production of mouldings;

FIG. 2B is a schematic illustration of a consolidated process according to the invention for the production and testing mouldings;

FIGS. 2C to 2F are actual embodiments of devices according to the invention for the production of mouldings;

FIG. 3 a schematic view of an embodiment of the injection unit shown in FIG. 1;

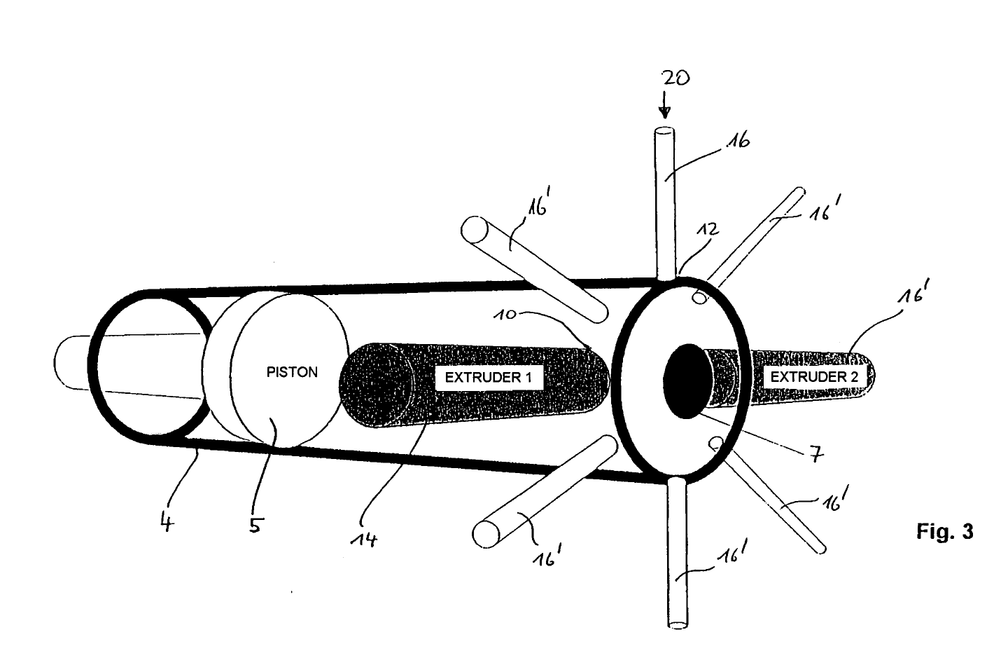

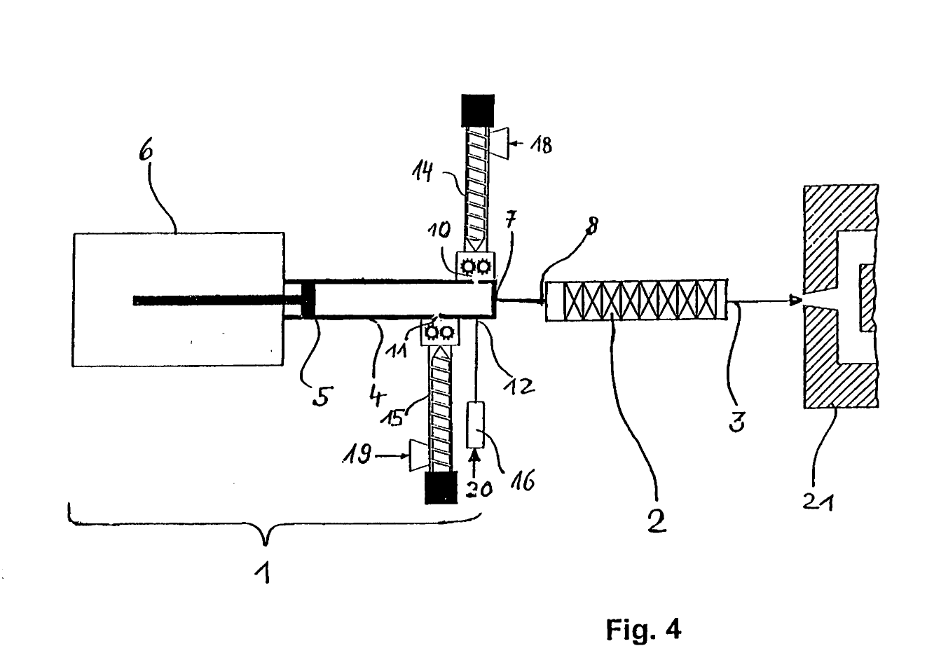

FIG. 4 is a schematic view of another embodiment of a device according to the invention for the production of mouldings;

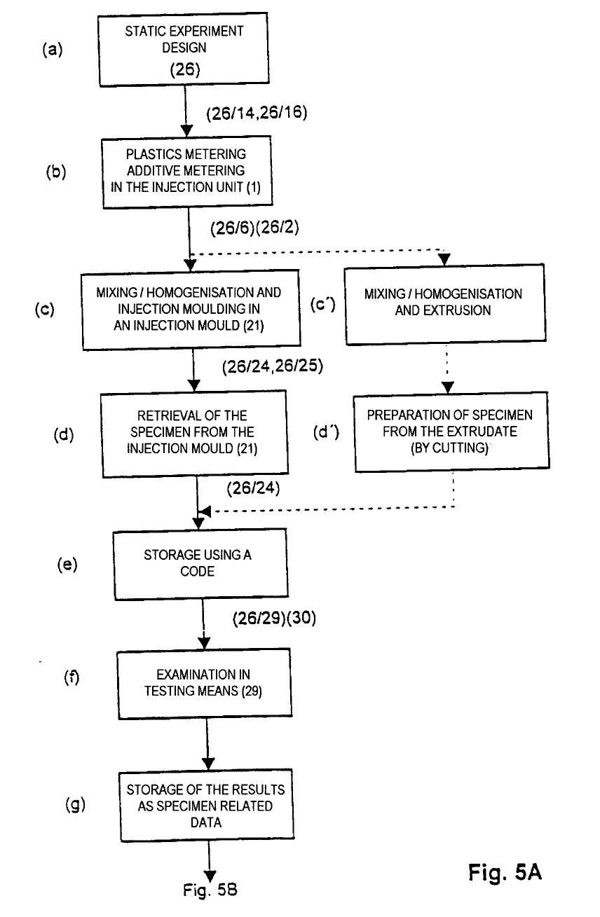

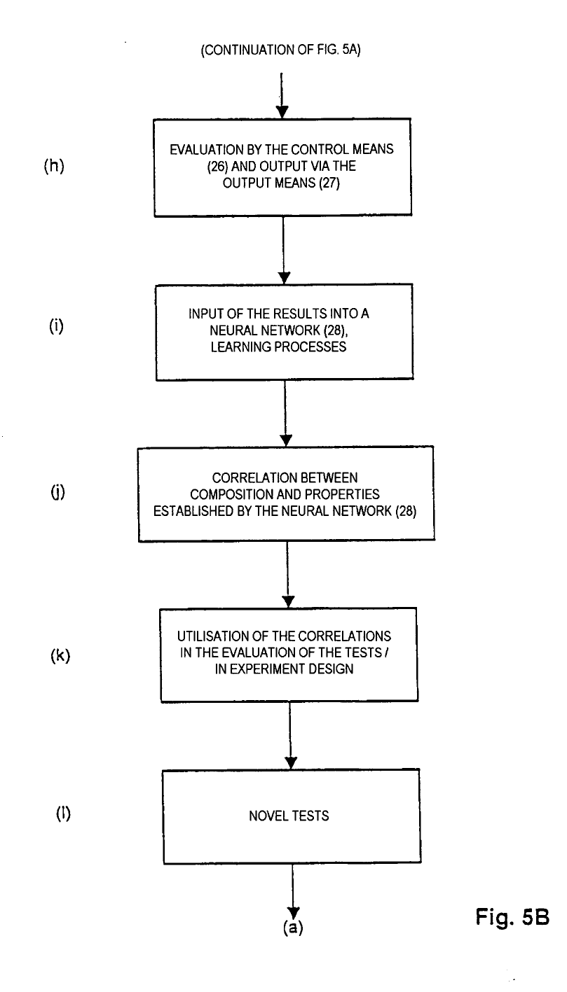

FIGS. 5A, 5B show a process flow diagram for a consolidated process according to the invention;

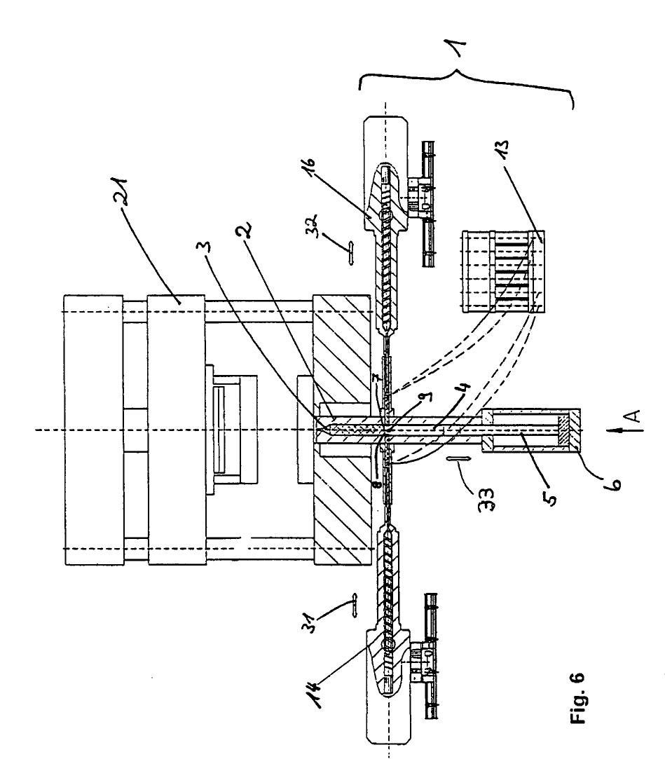

FIG. 6 is a schematic top view of an embodiment of a device according to the invention for the production of mouldings;

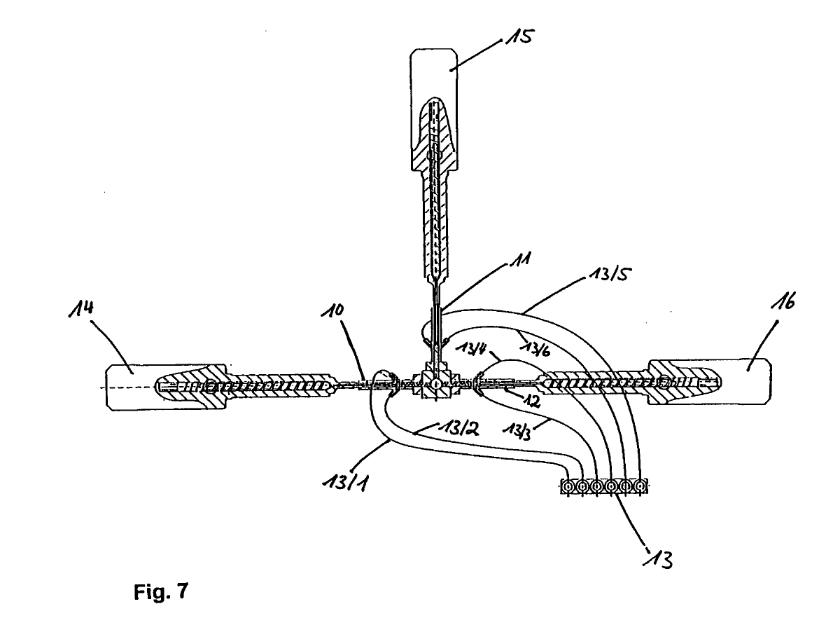

FIG. 7 is a view of the device according to FIG. 6 in the direction A in FIG. 6;

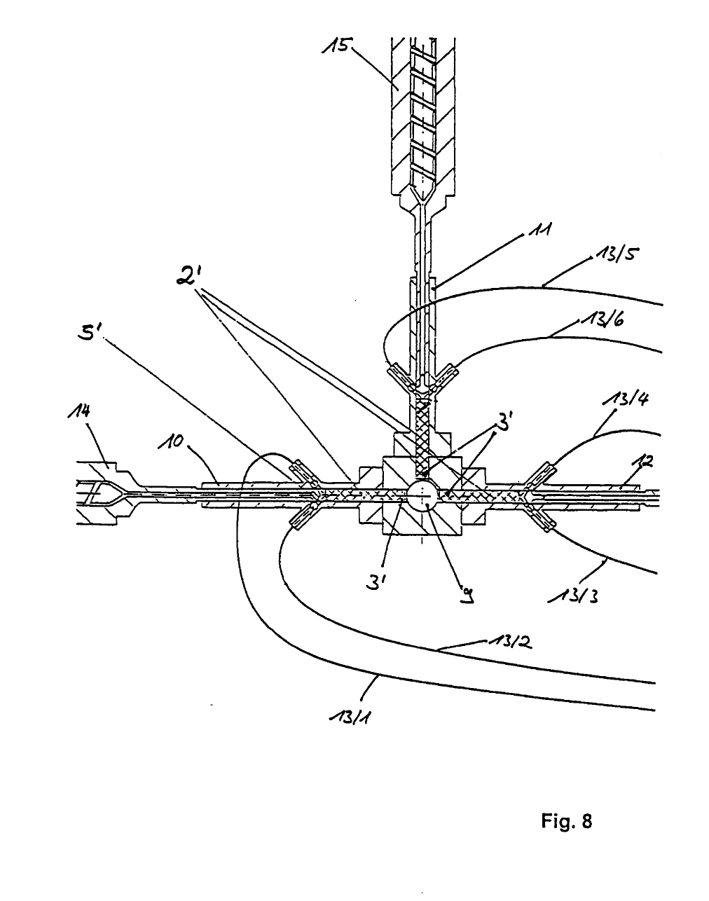

FIG. 8 is an enlarged section of the view of FIG. 7;

FIG. 9 is a schematic illustration of another embodiment of the device according to the invention for the production of mouldings;

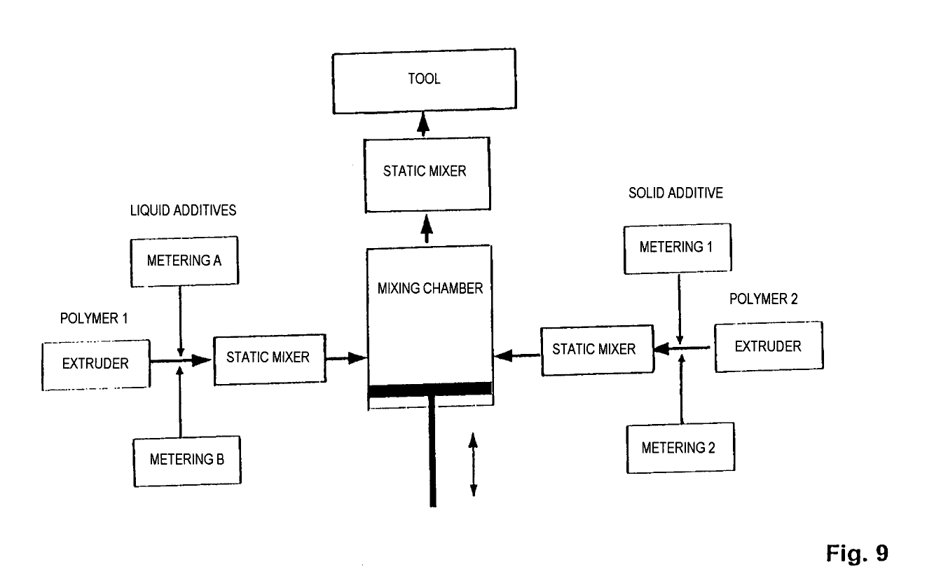

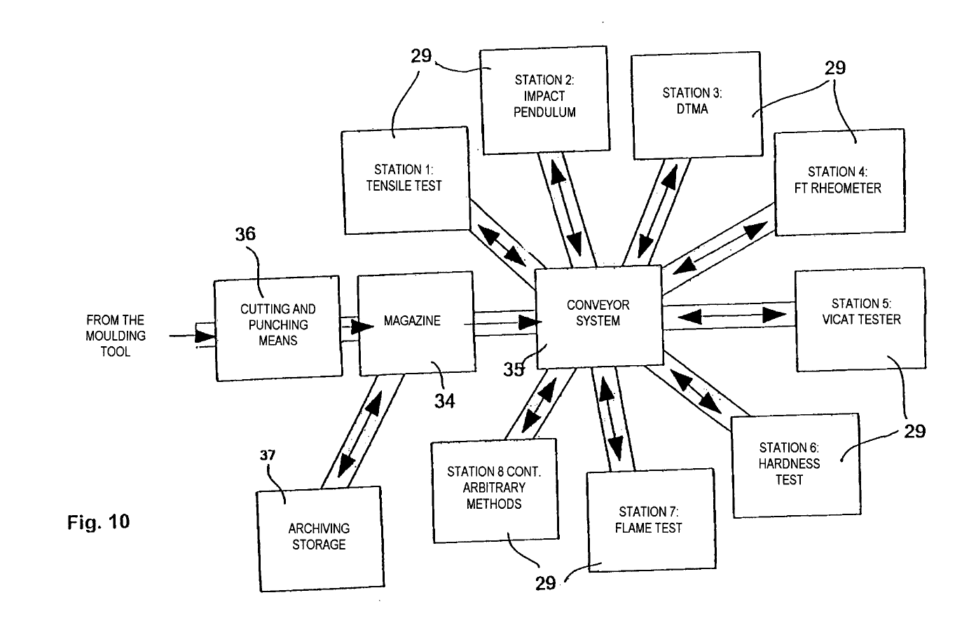

FIG. 10 is an embodiment of a device according to the invention for handling and testing mouldings comprising a conveyor system; and

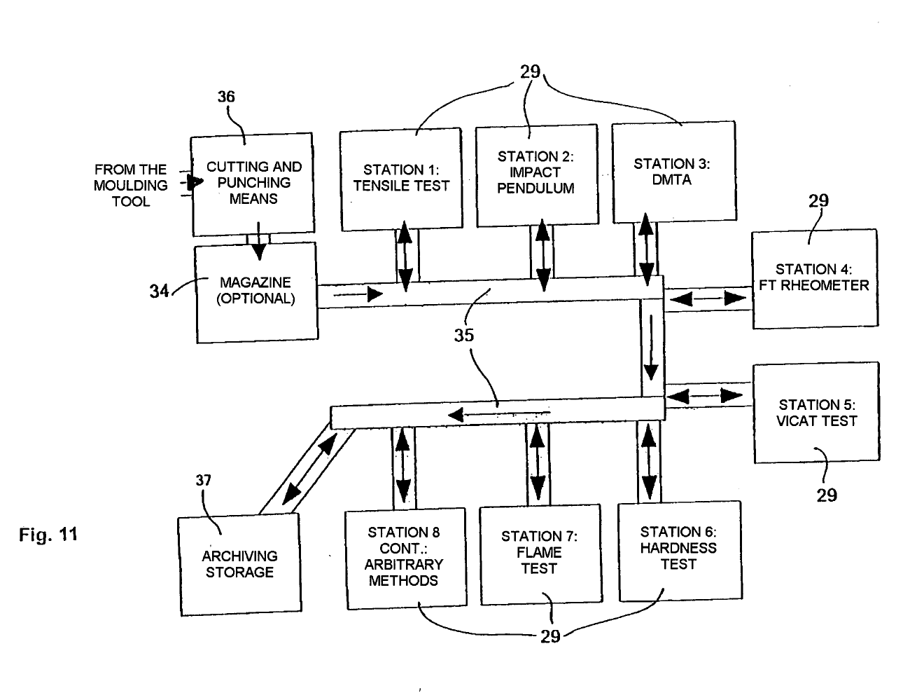

FIG. 11 is another embodiment of a device according to the invention for handling and testing mouldings comprising a conveyor system which differs from the one shown in FIG. 10.

In the following description of the embodiments the same numerals are used for identical elements.

FIG. 1A is a schematic illustration of the principle of the method according to the invention and the device according to the invention for the preparation of homogenous mixtures.

The device comprises two main components, a conveyor and rough mixer means 40 and a mixer means 53 disposed at the outlet 55 of the conveyor and rough mixer means 40.

The conveyor and rough mixer means 40 comprises a conveyor means 41 including one or more inlets 42 for at least one of the viscous or pasty fluids of the component system A or B as a material for the primary flow 43 and a rough mixer means 45 the main inlet 47 of which is connected to the downstream end 46 of the conveyor means 41.

The conveyor means 41 is formed so that it is capable of supplying the material of the primary flow 43 originating from a material supply 88 with a constant and selectable throughput and/or in a determinable quantity in a predetermined flow direction 44.

The primary flow 43 which, in particular, consists of a plastic material and advantageously forms the matrix material for the component system mixtures to be prepared is introduced into the rough mixer means 45 at the main inlet 47. The other components of the component system are brought in contact with or introduced into the primary flow 43 via the inlets 48. To this end introducing means 49 are provided for the secondary flows 50. The inlets 48 are preferably disposed close to the main inlet 47 and advantageously positioned substantially in the same plane 52 transverse to the flow direction 44 of the primary flow 43, i.e. approximately on the same axial level. The introducing means 49 are preferably formed so that the secondary flows 50 can be introduced with a constant and selectable throughput and/or in a selectable overall quantity.

As shown by the two arrows in the rough mixer means 45 symbolising the flow directions of the secondary flows 50 and of the primary flow 43 the rough mixed structure explained above will form during said operation. It was illustrated by coloured stripes on a strand of tooth paste and has, altogether, but not yet axially mixed, the respectively desired composition transverse to the flow direction within volume elements.

The downstream side outlet 55 of the rough mixer 45 is connected to the inlet 54 of the downstream mixer means 53 having a radial mixing effect. Said mixer means is preferably a static mixer. At the outlet 56 of the mixer means 53 the homogenous or quasi-homogenous mixture A or B is discharged and can then be tested and/or processed, particularly moulded.

Therefore preferably a moulding tool will be disposed downstream by which, preferably by means of injection moulding, mouldings, particularly specimen, may be produced.

The device according to the invention generally illustrated in FIG. 1A can also be formed or operated so that the flow direction 44 of the primary flow 43 and the flow direction of the secondary flows 50 during the preparation of the rough mixture is opposed to the flow direction of the mixture during the mixing operation or the injection operation.

Such a device is illustrated in FIG. 1B. In this device the rough mixer means 45 is formed as a piston conveyor means including a cylinder 4 and a piston 5 reciprocable therein and comprising a piston drive 6. On an axial level of the plane 52 the inlets 48 for the secondary flows 50 introduced by the introducing means 49 as well as the main inlet 47 for the primary flow 43 entering the rough mixer means 45 in the flow direction 44 from the end 46 of the conveyor means 41 are opening. The conveyor means 41 receives the material for the primary flow 43 from a material supply 88.

At the start of the preparation of the rough mixture the piston 5 is in an upper stroke position and is, as indicated by the arrow 1 showing the flow direction 44, moved to a lower stroke position, the primary flow 43 and the secondary flows 50 being in a way “sucked” into the cylinder 4. At that time the rough mixture having the explained mixture structure will form. During the following movement of the piston 5 into an upper stroke position the reversed flow direction 44 identified by 2 will result. Said extruding process leads to a discharge of the rough mixture from the outlet 55 of the rough mixer means 43, its introduction into the mixer means 53 through the inlet 54, its homogenisation there and its discharge through the outlet 56. During the extrusion or injection operation the primary flow 43 and the secondary flows 50 are blocked by valves, advantageously by check valves, if necessary.

The procedures of filling the rough mixer 45 and of discharging the corresponding mixtures therefrom will be effected in an alternating manner.

FIGS. 1C, 1D and 1E show different embodiments of the rough mixer means 45 or functionally important parts thereof. FIG. 1C shows a cylindrical element comprising orifices or nozzles 57 disposed at the circumference for introducing secondary flows 50, 51 into the primary flow 43.

FIG. 1D shows a shutter-like plate or disk 58 arranged perpendicular to the flow direction 44 of the primary flow 43 and provided with orifices or nozzles 57 for introducing secondary flows 50 through the inlets 48 opening in the downstream side 59 of the plate or disk 57.

FIG. 1E shows a substantially rotationally symmetric flow element 60 the rotational axis of which is parallel to the flow direction of the primary flow 43. The flow element 60 is provided with orifices or nozzles 57 for introducing secondary flows 50, 51 through inlets 48 preferably disposed on the downstream side of the flow element 60.

The device according FIG. 1 principally corresponding the one shown in FIG. 1B comprises an injection unit 1 comprising a cylinder 4 in which a piston 5 is housed so that it is axially movable therein as well as a piston drive 6 operationally connected to the piston 5.

On the outlet side 9 of the cylinder 4 inlets 10 and 12 are provided which are disposed radially on substantially the same axial level and open into a volume element VE disposed there. Alongside the outlet side volume element VE volume elements VEᵢ are shown which are to represent disk-shaped volume sections of the metered-in component system. Said volume sections extend across the radial cross section of the cylinder 4.

Supply means 14 and 16 for the components of the component system which are themselves provided with inlets 18 or 20 are connected to the inlets 10 and 12 in the cylinder 4.

The mixer means 2 which is a static mixer in the embodiment shown in FIG. 1 the inlet 8 of which is connected to the outlet 7 of the injection unit 1 is disposed downstream of the cylinder 4 in the conveying direction. The outlet 3 of the mixer 2, on the other hand, is connected or at least connectable to a moulding tool 21.

During the operation the components of the component system are introduced into the cylinder through the supply means 14, 16 when the piston 5 is returned from an upper stroke position into a lower stroke position. At that time a rough mixture forms in the cylinder 4, said rough mixture having a substantially uniform overall composition within the volume elements VEᵢ shown opposite the outlet side volume element VE on different axial levels of the cylinder 4. The rough mixture was explained above by the analogy with the “stripes on the toothpaste”.

The embodiment shown in FIG. 2A resembles the one shown in FIG. 1, is, however, further provided with a suitable discharge or metering means, e.g. a worm conveyor, a gear pump or a peripheral gate, disposed between the supply means 14 and the corresponding inlet 10 in the cylinder 4 to enable a metered supply of the components into the cylinder 4. Such a metering means may also be provided for the supply means 16.

In case of specific supply means, such as kneaders or extruders, the means itself may have a metering function which may, e.g., be controllable via the worm drive.

Furthermore metering means may be integrated with the cylinder 4 of the injection unit 1.

The piston drive 6 is preferably formed so that the returning and advancing of the piston 5 can be controlled. Further it is advantageous to use the delivery pressure of the supply means for pressing the piston 5 back or to at least support its return. The piston drive 6 is preferably formed so that it is capable of advancing the piston 5 in a shot-like manner when the rough mixture is pressed out through the mixer means 2 into the moulding tool 21 so that the static mixing as well as the injection moulding can be carried out efficiently.

A particularly advantageous embodiment of a device according to the invention is shown in FIG. 1F and has the following features:
the conveyor means 41 comprises a screw plasticizer unit 71 which can be supplied with the material for the primary flow from a material supply 88 through an inlet 42 and has an outlet side end which is connected to the rough mixer 45;
the plasticizer screw 61 of the plasticizer unit 71 is provided with an axial through hole through which a piston rod 62 passes which can be axially moved therein, a piston 63 being disposed at the end of the piston rod 62 at the outlet side end of the plasticizer unit;
the rough mixer 45 is connected to the housing 65 of the plasticizer unit 71 at its main inlet 47;
at the main inlet 47 of the rough mixer 45 a cylinder is provided into which the piston 63 can be moved when it is axially advanced by the piston rod 62, said cylinder being connected to the rough mixer 45 or being a part of the rough mixer 45;
the piston rod 62 and the piston 63 as well as the plasticizer screw 61 are driven by a drive unit 66 so that they are independently controllable whereby in the lower stroke position of the piston 63 the plasticized material of the primary flow 43 supplied by the plasticizer unit 71 through an annular clearance 64 provided between the piston 63 and the housing 65 can enter the rough mixer means 45 in the flow direction 44 and be brought in contact with the secondary flows 50, 51 and the annular clearance 64 and the inlets 48 of the rough mixer means 45 for the other components of the component system are closed by the piston 63 when the piston is axially advanced by the piston rod 62, the piston 63 conveying the resulting component system (A or B) enclosed in the rough mixer means 45 through the mixer means 53 at the outlet 56 of which the homogenised component system exists via the outlet 55 and the inlet 54 when it is further advanced.

FIG. 1G shows another advantageous embodiment of the device according to the invention which has the following features:
the conveyor means 41 comprises a screw plasticizer unit 71 which can be supplied with the material for the primary flow from a material supply 88 through an inlet 42, the outlet side end of the screw plasticizer unit 71 being connected to the rough mixer 45;
the plasticizer screw 61 of the plasticizer unit 71 is fixedly connected to a piston 63 at the outlet side end, the piston 63 being disposed in a cylinder 70 so as to be axially movable, the cylinder 70 being connected to the rough mixer 45 or forming a part of said rough mixer 45;
the piston 63 is provided with a central axial smelt channel 67 which is provided with a valve 69 at the free end of the piston 63, opens into the rough mixer means 45 and ends in radially positioned inlet orifices 68 in the area of the connection with the plasticizer screw 61 at its other end;
the plasticizer screw 61 and the piston 63 connected thereto are controllably driven by a drive unit 66 and can be axially shifted whereby in the lower stroke position of the piston 63 the plasticized material of the primary flow 43 supplied by the plasticizer unit 71 can enter the axial smelt channel 67 through the radial inlet orifices 68, be discharged into the rough mixer means 45 at its outlet side end and be brought in contact with the secondary flows 50, 51 in the flow direction 44, and the inlet of the primary flow 43 leading into the rough mixer means 45 is closed by the valve 69 as well as the piston 63 and the inlets 48 of the rough mixer means 45 for the other components of the component system are closed by the piston 63 when the piston 63 is axially advanced by the plasticizer screw 61, the piston 63 conveying the resulting component system (A or B) enclosed in the rough mixer means 45 through the mixer means 53 at the outlet 56 of which the homogenised component system exists via the outlet 55 and the inlet 54 when the piston 63 is further advanced.

Another advantageous embodiment is shown in FIG. 1H. It has the following features:
the conveyor means 41 comprises a screw plasticizer unit 71 which can be supplied with the material for the primary flow from a material supply 88 through an inlet 42, the outlet side end of the screw plasticizer unit 71 being connected to the rough mixer means 45;
the plasticizer screw 61 of the plasticizer unit 71 comprises an axial through hole through which a piston 63 passes which can be axially shifted therein, extends further on the outlet side end of the plasticizer unit 71 and is axially shiftable in a cylinder 70 which is connected to the rough mixer means 45 or is a part of the rough mixer means 45;
the piston 63 includes a central axial smelt channel 67 in the part disposed in the cylinder 70, said central axial smelt channel 67 is provided with a valve 69 at the free end of the piston 63, and it opens into the rough mixer means 45 and ends in radially positioned inlet orifices 68 at its other end which is disposed in the area of the outlet side end of the plasticizer unit 71;
the plasticizer screw 61 as well as the piston 63 are driven by a drive unit 66 so that they are independently controllable whereby in the lower stroke position of the piston 63 plasticized material of the primary flow 43 supplied by the plasticizer unit 71 can be introduced into the axial smelt channel 67 through the radial inlet orifices 68 and be discharged into the rough mixer means 45 at its outlet side end and be brought in contact with the secondary flows 50, 51 in the flow direction and the radial inlet orifices 68 and the inlets 48 of the rough mixer means 45 for the other components of the component system are closed by the piston 63 when the piston 63 is axially advanced by the plasticizer screw 61, the piston 63 conveying the resulting component system (A or B) enclosed in the rough mixer 45 means through the mixer 53 at the outlet 56 of which the homogenised component system exists via the outlet 55 and the inlet 54 when the piston 63 is further advanced.

FIG. 1I shows another advantageous device having the following features:
the conveyor means 41 comprises a screw plasticizer unit 71 controllably driven by a drive 66 and comprising a plasticizer screw 61 to which the material for the primary flow can be supplied by a material supply 88 through an inlet 42 as well as a cylinder 70 including a piston 63 axially shiftable therein, the cylinder 70 being connected to the rough mixer means 45 or being a part of the rough mixer means 45;
the cylinder 70 is provided with an inlet 72 disposed at the side, preferably perpendicular to its axis in the area of the end directed to the rough mixer means 45, said inlet 72 being connected to the outlet side end of the plasticizer unit 71 via a smelt channel 73;
the piston comprises a lateral inlet orifice 74 preferably positioned radially perpendicular to its axis to which a preferably orthogonally offset smelt channel 75 is connected which, starting at the inlet orifice 74, preferably first extends in the radial direction and then centrally in the axial direction of the piston 63 and opens in the rough mixer means 45;
the piston 63 is driven by a controllable drive unit 76 so that it is axially shiftable, whereby the inlet orifice 74 of the piston 63 is aligned with the inlet 72 of the cylinder 70 in the lower stroke position of the piston 63 so that plasticized material of the primary flow 43 supplied by the plasticizer unit 71 through the smelt channel 73 can be introduced into the smelt channel 75 of the piston 63 through the inlet 72 and the inlet orifice 74, from there flow into the rough mixer means 45 and there be brought in contact with the secondary flows 50, 51 in the flow direction 44, the piston 63 conveying the resulting component system (A or B) enclosed in the rough mixer means 45 through the mixer means 53 at the outlet 56 of which the homogenised component system exists via the outlet 55 and the inlet 54 when the piston 63 is further advanced.

Supply means similar to the ones used for the devices according to FIGS. 1F to 1I are per se known (see, for example EP 0 846 050), however, not for solving the object of the invention, i.e. the preparation of a rough mixture of a primary flow and secondary flows in a rough mixer means followed by its homogenisation.

FIG. 1J finally shows a particularly simple embodiment of the device according to the invention which has the following features:
the conveyor means 41 comprises a screw push extruder 77 including a push screw 78 to which the material for the primary flow can be supplied by a material supply 88 through an inlet 42, the outlet side end of said screw push extruder 77 being connected to the rough mixer 45;
the push screw 78 is controllably driven by a drive unit 66, the conveyed, plasticized material of the primary flow 43 being conveyed into the rough mixer means 45 in the flow direction 44 in the lowest stroke position of the push screw 78 to be brought in contact with the secondary flows 50, 51 introduced through the inlets 48 there, the resulting component system (A or B) being conveyed into the mixer 53 and filled into the moulding tool 21 when the push screw 78 is advanced.

FIG. 2B is a schematic illustration of the overall process for the production and testing of mouldings. The production process is followed by a test of the mouldings. A piston injection unit is used.

The injection unit 1 comprises a supply means 14 formed as a kneader or extruder including a metering means and a supply means 16 including an inlet 20.

The overall process is controlled by a control means 26 preferably formed as a computer or microprocessor system comprising an input means and an output means 27. The control means 26 may, however, as well be a computer network including a host computer or a programmable logic control.

The supply means 14, 16, the piston drive 6, the mixer means 2, the tool drive 25 controlling the movement of the half mould 23 and thus the closing and opening the moulding tool 21, a magazine system 24 and a testing means 29 are signal and data linked to the control means 26 as shown by the corresponding broken lines.

The various controls illustrated by broken lines are denoted as follows:

| | |
|---|---|
| 26/2 | control of the mixer means 2, |
| 26/6 | control of the piston drive 6, |
| 26/14 | control of the supply means 14 (e.g. plastic metering), |
| 26/16 | control of the supply means 16 (e.g. additive metering), |
| 26/24 | control of the magazine system 24, |
| 26/25 | control of the tool drive 25, |
| 26/29 | control of the testing means 29. |

In the example shown in FIG. 2B the control means comprises a neural network 28 which is advantageously implemented as software in the control means 26, for example to determine correlations between moulding compositions and test results.

The control means 26 is advantageously also suitable for the evaluation of test results which may be output via the output means 27.

It is to be expressly emphasised that FIG. 2B is not to be interpreted as if all signal and data links indicated by broken lines were mandatory. Depending on the respective application fewer or also more such links to the control means 26 may be provided.

The mixer means 2 is surrounded by the half mould 22 of the moulding tool 21 in this case. The magazine system 24 comprising at least one magazine is formed and controllable so that it can remove one or more produced mouldings from the moulding tool 21 and supply them on a conveyor path 30 to the testing means 29 or to a plurality of testing means for determining various material characteristics.

The test results can be displayed, printed or transferred for processing by the output means 27.

The cylinder 4 of a piston injection unit as in FIG. 2B shown in FIG. 3 comprises a plurality of supply means 14, 16, 16′ disposed radially at the outlet side end of the cylinder 4 on substantially the same axial level. They may, however, open into the cylinder 4 on different axial levels. The inlet 20 of the supply means 16 is shown.

In FIG. 4 another embodiment of a device according to the invention for producing mouldings by means of a piston injection unit is shown in which, in addition to the supply means 14, 16, another supply means 15 is disposed in the injection unit 1 on an axially different level with respect to the supply means 14 and 16. Said additional supply means 15 comprising the inlet 19 and a metering means opening into the cylinder 4 at the inlet 11 otherwise corresponds to the supply means 14.

A mixer means 2 mixing radially and axially and being connected to the outlet 7 of the injection unit 1 at its inlet 8 is provided downstream of the cylinder 4 in the conveying direction. The outlet 3 of the mixer means 2 is again connected to the moulding tool 21 or connectable to it. The supply means 14, 16, the mixer means 2 and/or the moulding tool 21 may be provided with rapid exchange links, e.g. with bayonet couplings.

In FIGS. 1K to 1P various embodiments of introduction means 49 for secondary flows (denoted as supply means 13 to 16 in FIGS. 1, 2A, 2B, 3 and 4) are shown which can be suitably used in the device according to the invention.

FIGS. 1K and 1L show simple screw plasticizer units 79, FIG. 1K showing a single screw device and FIG. 1L showing a double screw device. The plasticizer units 79 each comprise a drive unit 81 and are supplied with material for a secondary flow by a material supply 80. They are further provided with a valve 82, preferably a check valve, at the outlet side end.

FIG. 1M shows a piston injection device 83 comprising a drive unit 81 to which material for a secondary flow is supplied by a pump unit 84 via a material lead 85 comprising a valve 86. It comprises a valve on the outlet side end. Said device is particularly suitable for liquids.

FIGS. 1N and 1O show two similar introduction means 49 for secondary flows in the form or screw plasticizer units or screw extruders comprising a piston injection device; FIG. 1N showing a single screw device and FIG. 1O a double screw device.

The piston injection device 83 respectively comprises a drive unit 81 as well as an outlet side valve 82, as described above, and is supplied with material from a material supply 80 by the plasticizer unit 79 driven by a drive unit 81 via a material feeder 85 comprising a valve 86.

Finally FIG. 1P shows a screw plasticizer unit 79 supplied by a material supply 80, driven by a drive unit 81 and comprising an injection piston 87. Said device also comprises a valve 82, as described above. The plasticizer unit 79 schematically shown in FIG. 1P and comprising the injection piston 87 may be constructed similar to the piston plasticizer unit 71 of the devices shown in FIGS. 1F, 1G or 1H.

FIGS. 2C, 2D, 2E and 2F show embodiments of devices according to the invention for the production of mouldings, particularly from synthetic materials. For reasons of simplification all the devices are provided with the same conveying and rough mixer means respectively comprising a conveyor means including a plasticizer unit 71 having a piston 63 and a drive unit 66 supplied with material for the primary flow by a material supply 88. Said conveyor means may be of the type shown in FIGS. 1F, 1G or 1H. The rough mixer means is disposed between the plasticizer unit 71 serving as conveyor means and the mixer means 53 which is followed by a moulding tool 21.

The secondary flows, two of which are respectively shown, are supplied to the rough mixer means. In to FIG. 2C the introduction means for the secondary flows correspond to two piston injection units 83 according to FIG. 1M, in to FIG. 2D to a piston injection device 83 according to FIG. 1M and a piston plasticizer unit according to FIG. 1P, in FIG. 2E to two devices according to FIG. 1O, and in FIG. 2F to two piston plasticizer units according to FIG. 1P.

The embodiments shown in FIGS. 2C to 2F are, for example, suitable for the following applications:
Device according to FIG. 2C: mixing of a polymer material (primary flow) with two liquid additives of low viscosity, e.g. colour additives (secondary flows);
Device according to FIG. 2D: mixing of a polymer material, e.g. a polyamide, as a matrix material (primary flow) with an elastomer (introduced into the piston plasticizer unit 79 as a granulate) (secondary flow 1) and a liquid plasticizer (introduced through the piston injection device 83, secondary flow), for example for optimising the tensile strength of elastomer modified polyamide;
Device according to FIG. 2E: mixing of a polymer material, e.g. a PBT (polybutylene terephtalate) moulding mass as a matrix material (primary flow) with a PBT moulding mass and a stabiliser (in the form of a powder) (secondary flow 1) and another PBT moulding mass and a laser pigment (in the form of a powder) (secondary flow 2), for example for contrast optimisation in a laser inscribable PBT moulding mass;
Device according to FIG. 2F: mixing of a polymer material, e.g. PBT, as a matrix material (primary flow) with an elastomer 1 (granulate) (secondary flow 1) and an elastomer 2 (granulate) (secondary flow 2), for example for optimising the notch impact strength of PBT.

In FIGS. 5A and 5B individual steps of a consolidated process according to the invention up to the evaluation are shown in the form of a flow chart described in detail below.

Two more embodiments of a device according to the invention for the production of mouldings are shown in FIGS. 6, 7 and 8. The device shown in FIG. 6 comprises two and the device shown in FIGS. 7 and 8 comprises three main supply means 14, 15, 16.

The piston 5 accommodated in a housing so that it can be shifted by the piston drive 6 in the driving direction indicated by the double arrow 33 protrudes into the cylinder 4 of the injection unit 1 comprising the outlet 7 connected to the mixer means 2 in its fully retracted state.

The inlets 10, 11 and 12 for the supply means 14, 15 and 16 which can be reciprocated in the driving directions 31 or 32 indicated by double arrows are disposed at the outlet side end 9 of the cylinder 4. The outlet side end of the supply means 14, 15 and 16 is respectively formed as a metering piston 5′ comprising a return flow barrier at its tip which enables a material flow in the conveying direction but not in the opposite direction. The supply means 14, 15 and 16 are shown in a position in which they have been moved towards the cylinder 4.

Two leads 13/1 and 13/2, 13/3 and 13/4 or 13/5 and 13/6 from another supply means 13, e.g. a piston metering unit for liquid and pasty additives, respectively provided with a return flow barrier meet the inlets 10, 11 and 12.

Downstream of the ports comprising the return flow barriers in the conveying direction rough mixer means 2′ are disposed in the respective inlets 10, 11 and 12 of the cylinder 4. The rough mixer means 2′ are static mixers the outlets 3′ of which are opening radially at the outlet side end 9 of the cylinder 4.

Downstream of the cylinder 4 in the conveying direction the mixer means 2 is disposed which is a static mixer 2 the inlet 8 of which is directly connected to the outlet 7 of the injection unit 1. The outlet 3 of the static mixer means 2 is again connected to the moulding tool 21. The device according to FIGS. 6 to 8 thus does not use screw push extruders as supply means but supply means which also implement the principle of piston metering.

In the retracted supply means 14, 15, 16 the respective components are plasticized by an extruder and will reach the corresponding inlet 10, 11, 12 of the cylinder 4 in this state. In the same way liquid or pasty additives are metered into the inlets 10, 11, 12 by the additional supply means 13 depending on the formulas. When the metering process is completed the corresponding supply means 14, 15, 16 moves towards the cylinder and thus presses the plasticized material and the metered-in liquid and pasty additives into the rough mixer means 2′ for homogenisation. At that occasion the back flow barriers at the front end of the metering piston 5′ and the ports for the additives prevent a back flow of the components.

After the rough-mixed components from the supply means 14, 15, 16 have been introduced into the cylinder 4 through the outlet side end 9 of the cylinder the piston 5 will press them into the injection moulding tool 21 through the mixer means 2 for homogenisation.

When static mixers are used as mixer means the period of time during which the metered-in components are homogenised and pressed into the moulding tool 21 can be reduced to times in the range of seconds. In this way at least about 100 to 300 different mouldings having different compositions may be produced and tested for their material characteristics per day. That means this said rapid method enables the production and testing of mouldings from more than 10,000 plastics mixtures per year.

The sequence of a consolidated process comprising the preparation and testing of mouldings and the evaluation of the results will now be explained in detail with reference to FIGS. 5A and 5B.

After the determination or preparation of an operating schedule for the process in step (a), e.g. by statistical process scheduling, the control means 26 will control the temperable supply means 14, 16 via corresponding controls 26/14, 26/16 to plasticize the individual components. The number of the required supply means 14, 16 depends on the complexity of the component systems to be prepared.

Next the piston 5 is moved from an upper stroke position into a lower stroke position by the control 26/6 of the piston drive 6 and possibly the control 26/2 of the mixer means in step (b), the components of the component system being virtually drawn into the cylinder 4 or metered into the cylinder 4 by the supply means 14, 16.

The piston 5 may then be returned from its upper stroke position to its lower stroke position by the pressure of the introduced components, or its return movement induced by the control 26/6 of the piston drive 6 may be supported by it.

When the piston 5 is advanced the component system, particularly a plastic material, is mixed with one or more additives in a preferably heatable mixer means 2 and injected into an injection mould (step (c)) or extruded (step (c′)).

After the tool drive 25 acting on one half mould 23 of the moulding tool 21 has opened the moulding tool 21 under the control of the control means 26 implemented through the control link 26/25 the mouldings are removed by a magazine system 24 controlled by the control means 26 via the control link 26/24 and allocated to the moulding tool (step (d)), provided with an individual registered code and stored or temporarily stored in a magazine (step (e)). According to step (d′) the specimen may also be obtained from an extrudate by cutting or punching. With the aid of said code the results obtained in one or more tests carried out by testing means 29 can be allocated to the respective moulding and thus its respective composition. The code may also be used to localise the mouldings. Advantageously the testing means 29 are also controlled by the control means 26 via a control link 26/29.

From the magazine the mouldings are conveyed to the allocated testing means 29, where they are tested, via a conveyor path 30 (step (f)). The data obtained are stored (step (g)).

Said test results which are for example stored in a database can be evaluated, for example, by evaluation software and visualised by the output means 27, e.g. by graphics (step (h)). According to step (i) the results may be correlated with the composition of the specimen with the aid of suitable software, e.g. a neural network 28.

After a sufficient number of test cycles have been carried out a mathematical model can be obtained which respectively enables a correlation between the input variables and the test results, for example with the aid of a neural network (step j)). With this evaluation method as well as by statistical evaluation, for example, trends relating to the properties of the mouldings may be derived from test series with different compositions of the component system, which again enables an optimisation of the further experiment design (steps (k) and (l)).

The results obtained by the rapid screening methods according to the invention offer the user orientation and trend identification relating to the expected property profiles of the newly tested products. For examining the various properties typically the following testing methods are used:
rheologic properties: shear viscosity, melt flow index, flow spiral;
mechanical properties: elastic modulus, tensile strength, elongation at fracture, dynamic complex rigidity modulus, impact strength;
thermal properties: differential scanning calorimetry (DSC), flame tests, Vicat softening temperature, heat deflection temperature (HDT), thermal expansion;
electric properties: electric resistance, electric conductivity, disruptive strength, isolating properties, dielectric constant;
boundary surface properties: polarity, rim angle, roughness;
other properties: stress crack resistance, bio compatibility, UV-resistance, etc.;
optic properties: colour contrast, colour intensity, etc.

In FIG. 9 is a schematic illustration of another example of a device according to the invention for the production of mouldings.

The construction of said device is similar that of the devices according to FIGS. 6 to 8.

Two supply means provided for a polymer 1 and a polymer 2 open into the mixing chamber of the injection unit. They each comprise an extruder into which or at the outlet of which, in case of polymer 1, liquid additives (amounts A and B) and, in case of polymer 2, solid additives (amounts A and B) are introduced.

The material is respectively introduced into the mixing chamber of the cylinder of the injection unit in which the actual rough mixture is formed through a static mixer.

When the injection moulding (“shot”) is carried out the component system is injected into the moulding tool through a static mixer. For those skilled in the art it is obvious that the concrete embodiments shown in FIGS. 6 to 9 may be modified in various ways within the scope of the invention, particularly with respect to the type of supply means for the primary flow and the secondary flows and the type of mixers used. Due to this flexibility the methods and devices according to the invention can be adjusted to any component system.

The devices preferably have a modular design so that modifications of the devices can be carried out easily and rapidly.

FIGS. 10 and 11 show devices according to the invention for handling and testing mouldings which may be combined or integrated with devices according to the invention for the preparation of mouldings.

In both devices the mouldings coming from the moulding tool or a cutting and punching means 36 enter a conveying system 35 either directly or through an intermediate magazine 34.

The conveying system 35 of the device according to FIG. 10 is formed as a central system directly connected to all retrieval locations or return locations, i.e. in particular with a moulding tool, a cutting and punching means 36, a magazine 34, an archiving storage 37 and testing means 29, and can directly serve those addresses. The overall system is controllable by a control means.

The individual conveyor paths of the conveyor system 35 according to FIG. 10 may be arbitrarily formed, e.g. as robot systems, conveyor belts, trolley and rail track systems, moving carpet systems or the like, and particularly as a circulating structure.

The system according to FIG. 10 has constructive and economic advantages and can be operated with a high time efficiency due to the direct central transport of the mouldings.

The conveying system 35 of the device according to FIG. 11 is a system with a decentralised design which can, of course, advantageously be centrally controlled.

The conveying paths connect the individual addresses to each other in this example. This does not necessarily mean that there are direct connections from one address to another, it is also feasible to provide a higher ranking conveying system which can serve the individual addresses using switch-like devices.

In FIGS. 10 and 11 various testing means 29 are shown in the stations 1 to 7; station 8 indicates that any kind of other testing methods may be used.

The testing means 29 actually indicated in FIGS. 10 and 11 are of course only exemplary and explanatory since any other testing means 29 may be provided in any other combination and sequence.

According to an advantageous embodiment of the device according to FIGS. 10 and 11 the conveying system 35 may be formed so that it does not or not exclusively convey mouldings but one or more magazines as well. With this embodiment, for example, mouldings can be taken from or stored in a magazine 34 at certain addresses.

The devices according to FIGS. 10 and 11 are advantageously controllable by a control means.

One or more magazines 34 may be provided which may be joined to form a magazine system 24 (see FIG. 2B).

For each test series the number of specimen required for the various tests is prepared and can be stored or intermediately stored in the magazine system 24 or in one or more magazines 34.

The conveyor system 35 may, however, also be formed so that it directly retrieves the mouldings from the moulding tool or a cutting and punching means 36 and conveys them to scheduled addresses.

The transport of mouldings to and from different addresses, e.g. to and from testing means 29, may be effected sequentially and/or in parallel. Mouldings which have already been tested may be stored in an archiving storage 37 as recoverable samples. This is particularly reasonable in case of mouldings subjected to a non-destructive test which possibly is to be repeated. The conveyor system 35 may, finally, also convey mouldings to a garbage container in which, for example, the material is collected for recycling.

The methods and devices described above are particularly made use of in case of problems which require the preparation of a large number of specimen within a short period of time, such as:
examination of the miscibility of polymers,
examination of ternary or higher blends (miscibility, morphology, mechanical properties),
characterisation of the mechanical properties of binary, ternary or higher polymer mixtures,
determination of phase diagrams of binary, ternary or higher polymer mixtures,
optimisation of the mechanical properties of polymer blends depending on the composition,
development of phase mediators,
examination of the influence of a small amount of a third polymer on the phase behaviour and the mechanical properties of a binary polymer blend,
preparation and examination of blends of a flexible polymer (random coil polymer) and a main chain liquid crystalline polymer (rigid rod or extended rod polymer),
development of additives and additive combinations with enhanced effectiveness, reduced costs, reduced toxicity or enhanced environmental compatibility,
development of additives and additive combinations for new synthetic materials and new blends,
development of colorants, pigments, colour mixtures or colorations,
examination of stress crack formation in additive-containing polymers in the presence of solvents, oils, surface active agents, etc.,
examination and optimisation of mixtures of viscous media and possibly substances of low viscosity as used, for example, in cosmetics, foods, adhesives, etc.

A particularly advantageous aspect of the invention is the possible simultaneity of mixing the components and injecting the component system into the moulding tool by which the expenditure of time for a separate compounding as in the conventional methods can be avoided.

Particular advantages of the concept of the invention are as follows:
Due to the comparably very high speed of the production of mouldings having different material compositions a large number of mouldings having various material compositions can be prepared and tested within a relatively short period of time.
Due to the advantageous determination of correlations using a neural network as a system for trend identification it is no longer necessary to prepare and test mouldings produced from all possible combinations of the components of the component system.

The system for trend identification provides information on those variables the alteration of which has the strongest or most significant impact on the obtained/obtainable test results within a short period of time as compared to conventional methods mainly due to the correlation between the parameters (e.g. the material composition, the production conditions or the production method) and the corresponding test results.

When analysing the material properties of component systems it is therefore sufficient to prepare specimen from plastics mixtures previously identified as relevant or plastics mixtures which have been identified as relevant with the aid of the trend identification system in the course of a test series. These representative mouldings can than be specifically tested to verify the predicted properties.

The methods and devices according to the invention are not only applicable to and usable for the production of mouldings for material testing but particularly also for production methods. A variety of different products made from all materials which can be processed by the system can be produced, such as polymer blends, cosmetics (e.g. lipsticks) or pharmaceutical products (e.g. suppositories) but also food, particularly pastries (e.g. bread and cake) and toys (e.g. plasticine and the like).

### List of the Reference Numerals

1 injection unit
2 mixer means
2′ rough mixer means
3 outlet of the mixer means 2
3′ outlet of the rough mixer means 2′
4 cylinder
5 piston
5′ metering piston
6 piston drive
7 outlet of the injection unit 1
8 inlet of the mixer means 2
9 outlet side end of the cylinder 4
10 inlet of the cylinder 4
11 inlet of the cylinder 4
12 inlet of the cylinder 4
13 additional supply means
13/1 to 13/6 feeding lines of the supply means 13
14 supply means
15 supply means
16 supply means
16′ supply means
18 inlet of the supply means 14
19 inlet of the supply means 15
20 inlet of the supply means 16
21 moulding tool
22 mould half
23 mould half
24 magazine system
25 tool drive
26 control means
   Information flow
   26/2 control link to the mixer means 2
   26/6 control link to the piston drive 6
   26/14 control link to the supply means 14 (plastic metering, plasticization)
   26/16 control link to the supply means 16 (additive metering)
   26/24 control link to the magazine system 24
   26/25 control link to the tool drive 25
   26/29 control link to the testing means 29
27 output means
28 neural network
29 testing means
30 transfer path
31 drive means of the supply means 14
32 drive means of the supply means 16
33 drive means of the piston 5
34 magazine
35 conveyor system
36 cutting and punching means
37 archiving storage
40 conveyor and rough mixing means
41 conveyor means
42 inlet
43 primary flow
44 flow direction of the primary flow 43 or conveying direction
45 rough mixer means
46 downstream end of the conveyor means 41
47 main inlet of the rough mixer means 45
48 inlets for other components
49 introduction means for secondary flows 50, 51
50 secondary flow
51 secondary flow
52 plane
53 mixer means having a radial mixing effect
54 inlet of the mixer means 53
55 outlet of the rough mixer means 53
56 outlet of the mixer means 53
57 openings, nozzles
58 plate, disk
59 downstream side
60 flow element
61 plasticizer screw
62 piston rod
63 piston
64 annular clearance
65 housing
66 drive unit
67 smelt channel
68 inlet orifices
69 valve
70 cylinder
71 plasticizer unit
72 inlet
73 smelt channel
74 inlet orifice
75 smelt channel
76 drive unit
77 push screw extruder
78 push screw
79 plasticizer unit
80 material supply (material for the secondary flow 50, 51)
81 drive unit
82 valve
83 piston injection device
84 pump unit
85 material feeding line
86 valve
87 injection piston
88 material supply (material for the primary flow 43)
VE volume element at the end 9 of the cylinder 4 VEᵢ volume elements in the stroke range of the piston 5 in the cylinder 4

1. Method for the rapid preparation of homogenous or semi-homogenous mixtures having predetermined compositions from component systems
(A) of two or more viscous or pasty fluids or
(B) of one or more viscous or pasty fluids and one or more additives comprising the following process steps in the given sequence:
(I) generation of a flow having a constant and selectable throughput of at least one of the viscous or pasty fluids of the component system (A or B) (primary flow),
(II) introduction of the other components of the component system (A or B) in the form of one or more secondary flows having a constant and selectable throughput into the primary flow on substantially the same axial level with respect to a plane transverse to the flow direction of the primary flow so that the flow directions of the secondary flows are approximately parallel to the flow direction of the primary flow while forming a rough mixture flow of the components of the component system (A or B) having a substantially uniform overall composition corresponding to the predetermined composition within volume elements extending across the cross section of the rough mixture flow, and
(III) supply of a predetermined and selectable volume of the rough mixture flow through a mixer means having a radial mixing effect while obtaining a homogenous or semi-homogenous mixture of the component system (A or B).

2. Method according to claim 1, comprising the following additional process step following process step III:
(IV) preparation of one or more mouldings from the obtained homogenous or semi-homogenous mixture.

3. Method according to claim 2, wherein the production of the moulding or the mouldings is carried out in a paced manner, wherein
the process steps I to III are carried out in a mixture preparation stroke and
mouldings are produced from the homogenous or semi-homogenous mixture in one or more following moulding strokes,
after which the above sequence of a mixture preparation stroke and one or more following forming strokes can be repeated as often as desired.

4. Method according to claim 1 or 2, wherein the flow direction remains the same in the process steps (I), (II) and (III) and possibly also in process step (IV).

5. Method according to claim 1 or 2, wherein the process step (III) and, if applicable, also in process step (IV) the delivery of the rough mixture flow through the mixer means is effected in a flow direction opposed to the flow direction of the primary flow in process step (I) and of the rough mixture flow in process step (II).

6. Method according to claim 1 or 2, wherein in case of shaping by injection moulding the process step (III) and, if applicable, the process step (IV) as well are carried out with a higher mass or volume speed or with a higher throughput than the process steps (I) and (II).

7. Method according to claim 1, wherein a mixer means having a radial and an axial mixing effect or a combination of mixer means having a radial and/or an axial mixing effect is used in process step (III).

8. Method according to claim 1 or 2, wherein the homogenous or semi-homogenous mixture obtained after process step (III) is subjected to a reaction in a reactor or a reaction sector, if appropriate before a following process step (IV) is carried out.

9. Method according to claim 1 further comprising:
the introduction of the components of the component system (A or B) in predetermined quantity ratios into an injection unit (1) in which the viscous or pasty state of the component system remains unchanged,
the homogenisation or semi-homogenisation of the component system (A or B) in a mixer means (2) and
the production of one or more mouldings from the homogenised or semi-homogenised mixture, comprising
the use of an injection unit (1) substantially consisting of a cylinder (4) and piston (5) which can be axially shifted therein,
the simultaneous introduction of the components of the component system (A or B) into a volume element extending across the radial cross section of the cylinder (4) at the outlet side end (9) of the cylinder (4) of the injection unit (1) above the piston (5) while, at the same time, the piston (5) is returned from an uppermost stroke position to a lower stroke position, and preparation of a rough mixture of the components of the component system (A or B) having a substantially uniform overall composition corresponding to the predetermined composition within volume elements (VEᵢ) extending across the radial cross section of the cylinder (4),
the transport of the rough mixture through the mixer means (2) by advancing the piston (5) from the lower stroke position into an upper stroke position, and
the homogenisation or semi-homogenisation of the rough mixture in a mixer means (2) having a radial mixing effect, particularly in a static mixer device.

10. Method according to claim 1 further comprising:
the introduction of the components of the component system (A or B) in predetermined quantity ratios into an injection unit (1) in which the viscous or pasty state of the component system remains unchanged,
the homogenisation or semi-homogenisation of the component system (A or B) in a mixer means (2), and
the production of one or more mouldings from the homogenised or semi-homogenised mixture, comprising
the use of an injection unit (1) substantially consisting of a cylinder (4) and piston (5) which can be axially shifted therein,
the simultaneous introduction of the components of the component system (A or B) into the cylinder (4) of the injection unit (1) above the piston (5) while, at the same time, the piston (5) is returned from its uppermost stroke position to a lower stroke position, and preparation of a rough mixture of the components of the component system (A or B) having an overall composition which corresponds to the predetermined composition,
the transport of the rough mixture through the mixer means (2) by advancing the piston (5) from the lower stroke position into an upper stroke position, and
the homogenisation or semi-homogenisation of the rough mixture in a mixer means (2) having a radial and an axial mixing effect.

11. Method according to claim 1, wherein at least one of the viscous or pasty fluids is a molten plastic material, preferably a plastomer or a thermoplastic elastomer or the production of the mouldings is carried out by injection moulding or extruding.

12. Method according to claim 1, wherein at least one of the components of the component system (A or B) is a matrix material, particularly a molten plastic material, and at least one of the other components is an-additive, selected from the group consisting of fillers, colouring agents, polymer components, stabilisers, catalysers, flow and demoulding agents, lubricants and reactive components.

13. Method according to claim 1, wherein the components of the component system (A or B) are metered during their introduction into the cylinder (4) or that the primary flow (43) and the secondary flows (50, 51) are metered.

14. Method according to claim 1, wherein the introduction of at least one, of the components of the primary flow (43) and the secondary flows (50, 51) is controlled according to type, metering amount, metering speed, or a combination thereof.

15. Method according to claim 2, further comprising the execution of one or more of the following steps after process step (VI):
(a) sequential and/or parallel supply of the mouldings to a conveying system (35), possibly including the retrieval from a magazine (34);
(b) conveying the mouldings to one or more testing means (29), the transport to a plurality of testing means (29) being carried out sequentially and/or in parallel;
(c) implementation of the corresponding test(s) in one or more testing means (29), the mouldings being tested sequentially and/or in parallel in the testing means (29) if a plurality of tests are carried out;
(d) sequential or parallel removal of the mouldings or products prepared therefrom from the testing means (29) and insertion into a magazine (34), an archiving storage or a garbage container after the implementation of the test(s);
preferably including one or more of the detection, processing or transfer of test results in or after step (c).

16. Method according to claim 15, wherein at least one conveying operation, particularly in steps (a), (b) or (d), or the tests in step (c) or the detection, processing, evaluation or transfer of test results are controlled by a control means (26) preferably using central data collection and data processing, particularly using one or more of a computer system or a micro processor system or a programmable logic control.

17. Device for the rapid preparation of homogenous or quasi-homogenous mixtures having a predetermined composition from component systems
(A) of two or more viscous or pasty fluids or
(B) one or more viscous or pasty fluids and one or more additives, particularly for the implementation of the method according to claim 1 comprising
a supply and rough mixer means (40) including
conveying means (41) having one or more inlets (42) for at least one of the viscous or pasty fluids of the component systems (A or B) as a material for a primary flow (43) which can supply the material as a primary flow (43) with a constant and selectable throughput in a predetermined flow direction, and
a rough mixer means (45) preferably disposed on the downstream end (46) of the conveying means (41) and comprising
a main inlet (47) for the primary flow (43) from the conveying means (41),
one or more inlets (48) for the other components of the component system (A or B) disposed substantially in the same plane (52) transverse to the flow direction (44) of the primary flow (43) and preferably positioned near the main inlet (47) or at the main inlet (47), and
introduction means (49) connected to the inlets (48) and formed so that the other components of the component system (A or B) cam be brought in contact with and/or introduced into the primary flow (43) in the form of one or more secondary flows (50, 51), as well as
mixer means (53) having a radial mixing effect the inlet (54) of which is disposed at the outlet (55) of the rough mixer means (45) and at the outlet (56) of which the homogenous or semi-homogenous mixture of the component system (A or B) is discharged.

18. Device according to claim 17, wherein
the main inlet (47) of the rough mixer means (45) for the primary flow (43) is disposed on the outlet side of the rough mixer means on substantially the same axial level (51) as the inlets (48) for the secondary flows (50, 51),
the rough mixer means (45) comprises an own conveyor means (5, 6) having two opposed, reversible supply directions and can be filled with the material of the primary flow (43) and the secondary flow(s) (50) in the first conveying direction (44, 1.), at which occasion the primary flow (43) contacts the secondary flows (50, 51), while in the second conveying direction (44, 2.) the rough mixture of the components of the component system (A or B) formed in the rough mixer means (45) can be conveyed into or through the mixer means (53).

19. Device according to claim 17 further comprising a moulding tool (21) connected or connectable to the outlet (56) of the mixer means (53), preferably an injection moulding or continuous casting tool.

20. Device according to claim 18 wherein the conveying means (5, 6) of the rough mixer means (45) substantially consists of a piston (5) disposed in a cylinder (4) provided therein and a piston drive (6) (injection unit), the piston being axially reciprocable within the cylinder (5), a rough mixture of the components of the component system (A or B) being formed from the primary flow (43) and the secondary flow(s) (50) flowing in a first flow direction (44, 1.) when the piston (5) is returned into a lower stroke position which rough mixture can be conveyed into or through the mixer device when the piston (5) is then advanced into an upper stroke position.

21. Device according to claim 17, wherein the rough mixer (45) is formed
as a substantially cylindrical element provided, at the circumference, with one or more orifices or nozzles (57) opening into the primary flow (43) for introducing secondary flows (50, 51) through the inlets (48), or
as a shutter-like plate or disk (58) disposed perpendicular to the flow direction (44) of the primary flow (43) through, or around, or through and around which the primary flow can flow, said plate or disk (58) comprising openings or nozzles (57) opening into the primary flow axially in the flow direction or in a direction perpendicular to the flow direction (44) of the primary flow (43) on the downstream side (59) of the plate or disk (58) for introducing secondary flows (50, 51) through the inlets (48) or
as a preferably substantially rotationally symmetric flow body (60) disposed in the primary flow (43), the primary flow (43) flowing around said flow body, and provided with openings or nozzles (57) opening into the primary flow (43) downstream of the flow body (60) for introducing secondary flows (50, 51) through the inlets (48).

22. Device according to claim 17, further comprising a modular construction, the supply means (41), the rough mixer means (45) and the mixer means (53) as well as possibly the moulding tool (21) being formed as modules which are preferably detachably connected to each other by means of quick-action fastenings.

23. Device according to claim 17, wherein the conveying means (41) substantially consists of a unit formed by a plasticizer screw (61) and a piston (63).

24. Device according to claim 17, comprising the following features:
the conveyor means (41) comprises a screw plasticizer unit (71) which can be supplied with the material for the primary flow through an inlet (42), the outlet side end of the screw plasticizer unit (71) being connected to the rough mixer (45);
the plasticizer screw (61) of the plasticizer unit (71) is provided with an axial through hole through which a piston rod (62) passes which can be axially moved therein, a piston (63) being disposed at the end of the piston rod (62) at the outlet side end of the plasticizer unit;
the rough mixer means (45) is connected to the housing (65) of the plasticizer unit (71) at its main inlet (47);
at the main inlet (47) of the rough mixer means (45) a cylinder is provided into which the piston (63) can be moved when it is axially advanced by the piston rod (62), said cylinder being connected to the rough mixer means (45) or being a part of the rough mixer means (45);
the piston rod (62) and the piston (63) as well as the plasticizer screw (61) are driven by a drive unit (66) so that they are independently controllable whereby in the lower stroke position of the piston (63) the plasticized material of the primary flow (43) supplied by the plasticizer unit (71) through an annular clearance (64) provided between the piston (63) and the housing (65) can enter the rough mixer means (45) in the flow direction (44) and be brought in contact with the secondary flows (50, 51), and the annular clearance (64) and the inlets (48) of the rough mixer means (45) for the other components of the component system (A or B) are closed by the piston (63) when the piston is axially advanced by the piston rod 62, the piston (63) conveying the resulting component system (A or B) enclosed in the rough mixer means (45) through the mixer means (53) when the piston (63) is further advanced.

25. Device according to claim 17, comprising the following features:
the conveyor means (41) comprises a screw plasticizer unit (71) which can be supplied with the material for the primary flow through an inlet (42), the outlet side end of the screw plasticizer unit (71) being connected to the rough mixer (45);
the plasticizer screw (61) of the plasticizer unit (71) is fixedly connected to a piston (63) at the outlet side end, the piston (63) being disposed in a cylinder (70) so as to be axially movable, the cylinder (70) being connected to the rough mixer (45) or forming a part of said rough mixer (45);
the piston (63) is provided with a central axial smelt channel (67) which is provided with a valve (69) at the free end of the piston (63), opens into the rough mixer means (45) and ends in radially positioned inlet orifices (68) in the area of the connection to the plasticizer screw (61) at its other end;
the plasticizer screw (61) and the piston (63) connected thereto are controllably driven by a drive unit (66) and can be axially shifted whereby in the lower stroke position of the piston (63) the plasticized material of the primary flow (43) supplied by the plasticizer unit (71) can enter the axial smelt channel (67) through the radial inlet orifices (68), be discharged into the rough mixer means (45) at its outlet side end and be brought in contact with the secondary flows (50, 51), and the inlet of the primary flow (43) leading into the rough mixer means (45) is closed by the valve (69) and the inlets (48) of the rough mixer means (45) for the other components of the component system (A or B) are closed by the piston (63) when the piston (63) is axially advanced by the plasticizer screw (61), the piston (63) conveying the resulting component system (A or B) enclosed in the rough mixer means (45) through the mixer means (53) when the piston (63) is further advanced.

26. Device according to claim 17, comprising the following features:
the conveyor means (41) comprises a screw plasticizer unit (71) which can be supplied with the material for the primary flow through an inlet (42), the outlet side end of the screw plasticizer unit (71) being connected to the rough mixer means (45);
the plasticizer screw (61) of the plasticizer unit (71) comprises an axial through hole through which a piston (63) passes which can be axially shifted therein, extends further on the outlet side end of the plasticizer unit (71) and is axially movable in a cylinder (70) which is connected to the rough mixer means (45) or is a part of the rough mixer means (45); the piston (63) includes a central axial smelt channel (67) in the part disposed in the cylinder (70), said central axial smelt channel (67) is provided with a valve (69) at the free end of the piston (63), and it opens into the rough mixer means (45) and ends in radially positioned inlet orifices (68) at its other end which is disposed in the area of the outlet side end of the plasticizer unit (71);
the plasticizer screw (61) as well as the piston (63) are driven by a drive unit (66) so that they are independently controllable whereby in the lower stroke position of the piston (63) plasticized material of the primary flow (43) supplied by the plasticizer unit (71) can be introduced into the axial smelt channel (67) through the radial inlet orifices (68), and be discharged into the rough mixer means (45) at its outlet side end and brought in contact with the secondary flows (50, 51), and the radial inlet orifices (68) and the inlets (48) of the rough mixer means (45) for the other components of the component system (A or B) are closed by the piston (63) when the piston (63) is axially advanced by the plasticizer screw (61), the piston (63) conveying the resulting component system (A or B) enclosed in the rough mixer (45) means through the mixer means (53) when the piston (63) is further advanced.

27. Device according to claim 17, comprising the following features:
the conveyor means (41) comprises a screw plasticizer unit (71) controllably driven by a drive (66) and comprising a plasticizer screw (61) to which the material for the primary flow can be supplied through an inlet (42) as well as a cylinder (70) including a piston (63) axially movable therein, the cylinder (70) being connected to the rough mixer means (45) or forming a part of the rough mixer means (45);
the cylinder (70) is provided with an inlet (72) disposed at the side, preferably perpendicular to the axis of cylinder (70) in the area of the end directed to the rough mixer means (45), said inlet (72) being connected to the outlet side end of the plasticizer unit (71) via a smelt channel (73);
the piston (63) comprises a lateral inlet orifice (74) preferably positioned radially perpendicular to the axis of the piston (63) to which a preferably orthogonally curved smelt channel (75) is connected which, starting at the inlet orifice (74), preferably first extends in the radial direction and then centrally in the axial direction of the piston (63) and opens into the rough mixer means (45);
the piston (63) is driven by a controllable drive unit (76) so that it is axially movable, whereby the inlet orifice (74) of the piston (63) is aligned with the inlet (72) of the cylinder (70) in the lower stroke position of the piston (63) so that plasticized material of the primary flow (43) supplied by the plasticizer unit (71) through the smelt channel (73) can be introduced into the smelt channel (75) of the piston (63) through the inlet (72) and the inlet orifice (74), from there flow into the rough mixer means (45) and there be brought in contact with the secondary flows (50, 51), the piston (63) conveying the resulting component system (A or B) enclosed in the rough mixer means (45) through the mixer means (53) when the piston (63) is further advanced.

28. Device according to claim 17, comprising the following features:
the conveyor means (41) comprises a screw push extruder (77) including a push screw (78) to which the material for the primary flow can be supplied through an inlet (42), the outlet side end of said screw push extruder (77) being connected to the rough mixer (45);
the push screw (78) is controllably driven by a drive unit (66), the conveyed, plasticized material of the primary flow (43) being conveyed into the rough mixer means (45) in the lowest stroke position of the push screw (78) to be brought in contact with the secondary flows (50, 51), the resulting component system (A or B) being conveyed into the mixer means (53) and filled into the moulding tool (21) when the push screw (78) is advanced.

29. Device according to claim 17, wherein one or more of the supply means (14, 15, 16, 16′) or one or more introduction means (49) for secondary flows (50, 51) or the conveyor means (41) or a combination thereof have a metering function or comprise a metering means.

30. Device according to claim 17, comprising
a conveying system (35) and
one or more testing means (29) for testing the properties of the mouldings wherein the conveying system (35) can carry out at least one of the following functions:
(i) gathering or receiving mouldings from a moulding tool (21), a cutting or punching device (36), a magazine system (24), a magazine (34) and/or an archiveing storage (37),
(ii) conveying mouldings to one or more testing means (29),
(iii) conveying mouldings from one or more testing means (29) to one or more other testing means (29),
(iv) conveying mouldings from one or more testing means (29) to a magazine system (24), a magazine (34), an archiving storage (37) and/or a garbage container,
(v) conveying mouldings from one magazine system (24) or magazine (34) to another magazine system (24) or magazine (34),
(vi) application of a code to mouldings or magazines (34) and/or reading codes on mouldings or magazines (34) and controlling the conveying operations depending on the codes,
(vii) conveying magazines in which mouldings can be stored to discharging or returning locations
wherein preferably one or more of the functions (i) to (vii) can be carried out sequentially, in parallel, or a combination thereof.

31. Device according claim 30, comprising a magazine system (24) comprising one magazine (34) or a plurality of magazines (34) in which produced mouldings can be stored or intermediately stored.

32. Device according to claim 17, wherein one or more introduction means (49) for secondary flows (50, 51) or the conveyor means (41) for the primary flow (43) or a combination thereof is a device according to claim 17 or 18.

33. Device according to claim 17, comprising a control means (26) controlling one or several or all functions of the device.
